(19) United States
(12) Patent Application Publication
(10) Pub. No.: US 2011/0149960 A1
(43) Pub. Date: Jun. 23, 2011

(54) METHOD AND APPARATUS FOR FILTERING MULTICAST PACKETS

(75) Inventor: Álvaro Fernández Gutiérrez, Barcelona (ES)

(73) Assignee: MEDIA PATENTS, S.L., Barcelona (ES)

(21) Appl. No.: 12/723,461

(22) Filed: Mar. 12, 2010

(30) Foreign Application Priority Data
Dec. 17, 2009 (ES) P200931198

(51) Int. Cl. H04L 12/56; H04L 12/28

(52) U.S. Cl. 370/390; 370/389; 370/400

(57) ABSTRACT

A method of filtering multicast packets received in a first network interface of a router is provided. The router receives multicast traffic in the first network interface from sources that send multicast packets to at least a first multicast group address. The router also having second and third network interfaces for receiving multicast traffic requests. In one implementation the filtering method includes receiving in the second network interface a first multicast traffic request for a first multicast group address according to a first multicast routing protocol including a first set of sources, receiving in the third network interface a second multicast traffic request for the first multicast group address according to a second multicast routing protocol, the multicast traffic request including a second set of sources, creating from the first and second multicast traffic requests a filter record having a third set of sources indicative of all of the sources of the first multicast group address requested to be transmitted through the second and third interfaces of the router; and filtering multicast packets received at the first network interface using the record. In alternative embodiments, multiple multicast state records (e.g., an Include source record and an Exclude source record) are stored for each network interface and multicast group address, the multiple multicast state records being used to create one or more multiple filter records that each have a set of sources that are used in combination to filter multicast packets received at the first network interface.

### CROSS-REFERENCE TO RELATED APPLICATIONS

This application claims priority to Spanish Patent Application No. P200931198, filed Dec. 17, 2009.

### TECHNICAL FIELD

The invention relates to the field of multicast network technology and more particularly to a method of filtering multicast packets received in a network interface of a router or similar devices.

### BACKGROUND

Multicast technology makes it possible to send data from a single source to many recipients through a data network, without having to set up unicast communication, i.e. one-to-one individual communication between the source and each of the recipients. To that end, the source sends data, in data packet form, to a single address associated to a multicast group to which the equipment interested in being recipients of the data sending can subscribe. This address referred to as a multicast address or also as a multicast group address, is an IP (Internet Protocol) address chosen within a range that is reserved for multicast applications. The data packets which have been sent by the source to the multicast address are then replicated in the different network routers so that they can reach the recipients that have joined the multicast group.

The recipients that receive data in a multicast group are usually, but not always, equipment connected to the data network by means of a proxy or a router. Hereinafter, the term “host” will be used to refer to the recipient equipment. A host can be, for example, a computer, a set-top box (digital signal decoder) connected to a television set, a mobile device, such as a mobile phone, or any other device capable of receiving data packets.

When a host wants to receive the information sent by one or several sources of a multicast group, it usually sends via a router or an intermediate proxy a subscription message to subscribe to the group so that the router transmits to it the data arriving through the data network and which has been sent by the sources of the multicast group. Likewise, when a host wishes to stop receiving data packets from a multicast group, it usually sends via the router or the proxy an unsubscribe message to stop receiving the data packets.

The messages exchanged between a host and a router to manage membership to a multicast group generally use the IGMP protocol (Internet Group Management Protocol) or the MLD (Multicast Listener Discovery) protocol, according to whether or not the router works with version 4 (IPv4) or version 6 (IPv6) of the IP protocol (Internet Protocol), respectively. When there is a proxy between the host and the router, the proxy also uses the IGMP/MLD protocols to exchange with the host, the closest router or other intermediate proxy, the multicast group membership messages. In these cases, the proxy can receive from different hosts requests to subscribe to or to unsubscribe from a multicast group, and it assembles them to thus reduce IGMP/MLD message traffic it sends to the router. Hereinafter, the generic term IGMP proxy will be used to designate a proxy using the IGMP/MLD protocols.

FIGS. 1, 2, and 3 show different messages used in the IGMPv3 (IGMP version 3) protocol. FIG. 1 shows a “Membership Query Message” which is a message sent by IGMPv3 routers to the hosts so that the hosts respond with messages that indicate the multicast traffic that they wish to receive. FIG. 2 shows a “Membership Report Message” which is a message sent by the hosts to the routers to indicate the multicast traffic that they wish to receive. This information sent by the hosts in the Membership Report type messages is organized into different blocks of data referred to as “Group Records”. The structure of these group records is shown in FIG. 3.

In addition, routers exchange messages with one another for the purpose of defining the routing which allows efficient routing of the data from the sources to the hosts that have subscribed to a multicast group. To that end, the routers use specific protocols, including the very well known PIM-SM (Protocol Independent Multicast-Sparse Mode).

In summary, the routers receive from the hosts, in the form of IGMP/MLD messages, information specifying which multicast groups they want to receive traffic from, and they communicate with other routers, for example by means of the PIM-SM protocol, for the purpose of setting up a routing which takes the traffic requested by the hosts to such hosts. All of the aforementioned protocols are defined and documented by the Internet Engineering Task Force (IETF).

The IGMP protocol version currently being used is IGMPv3, which is described in the RFC 3376 specifications published on line by the IETF (B. Cain et al., Engineering Task Force, Network Working Group, Request for Comments 3376, October 2002; currently available at Internet address http://tools.ietf.org/html/rfc3376).

With regard to the MLD protocol, the version currently being used is MLDv2, which is described in the RFC 3810 specifications published on line by the IETF (R. Vida et al., Engineering Task Force, Network Working Group, Request for Comments 3810, June 2004; currently available at Internet address http://tools.ietf.org/html/rfc3810).

The operation of an IGMP proxy is described in the RFC 4605 specifications published on line by the IETF (B. Fenner et al., Engineering Task Force, Network Working Group, Request for Comments 4605, August 2006; currently available at Internet address http://tools.ietf.org/html/rfc4605).

The PIM-SM protocol used for the communication between routers is described in the RFC 4601 specifications published on line by the IETF (B. Fenner et al., Engineering Task Force, Network Working Group, Request for Comments 4601, August 2006; currently available at Internet address http://tools.ietf.org/html/rfc4601).

Multicast technology was initially implemented primarily to be applied to the many-to-many communication model, known as ASM (Any Source Multicast), in which many users communicate with one another and any of them can send data and also receive data from everyone else. A typical ASM application is multiparty calling via Internet. Multicast technology was then implemented to be applied to the one-to-many communication model known as SSM (Source Specific Multicast), in which a single source sends data for many recipients.

In earlier IGMP protocol versions, a host could not choose the data sending sources it did not want to subscribe to within a multicast group, rather the host could only subscribe to or unsubscribe from the group for all the sources. The messages a host sent to a router were very simple: Join (G) to receive traffic from the multicast group G and Leave (G) to stop receiving it. Therefore, earlier IGMP protocol versions did not allow SSM. The possibility that the hosts could choose the sources within a multicast group was introduced in the IGMPv3 version of the IGMP protocol to allow SSM. To that end, a host can send IGMP messages containing data blocks referred to as Group Record in which the host defines the sources from which traffic is to be received for each multicast group. These Group Record data blocks in an IGMP message can be of several types:
An INCLUDE type Group Record data block containing information on source IP addresses from which the host wishes to receive data sending. According to the terminology of the RFC 3376 specifications, the sources chosen by means of an IGMP message containing an INCLUDE type Group Record are referred to as INCLUDE sources.
An EXCLUDE type Group Record data block, containing information on source IP addresses from which the host does not wish to receive data sending. In this case, it is interpreted that the host wishes to receive data sent by all the sources of the multicast group except the sources indicated as excluded in the message. According to the terminology of the RFC 3376 specifications, the excluded sources by means of an IGMP message containing an EXCLUDE type Group Record are referred to as EXCLUDE sources.

Channel (S, G) is used hereinafter, and according to the common nomenclature in SSM technology, to refer to the sending of source S of the multicast group G.

In the third version of the IGMP protocol (IGMPv3) it was decided that for a multicast group each network interface can only operate in one of the following modes, being able to pass from one to another: the INCLUDE mode, where the network defines a list of INCLUDE sources, or the EXCLUDE mode, where the network defines a list of EXCLUDE sources. The RFC 3376 specifications describe a method with which the hosts can select the multicast traffic that they wish to receive. A brief summary of this operation is provided below.

Paragraph 2, entitled “The Service Interface for Requesting IP Multicast Reception” of the RFC 3376 specifications describes a service interface that can be used by the upper network layers of the host protocols or the host programs in order to request that the IP network layer accept or reject the multicast traffic from certain multicast addresses. For this purpose, it uses a function known as IPMulticastListen.

The RFC 3376 specifications of the IGMPv3 explain that the systems must support the following function, which enables a host to choose the multicast data sources:

IPMulticastListen (socket, interface, multicast-address, filter-mode, {source-list})
where:
“socket” is a parameter used to distinguish the different applications that are executed on the system (for example, programs and processes) and which call to the IPMulticastListen function.
“interface” is a local identifier for the network card or network interface on which one wishes to receive the multicast traffic indicated in the call to the IPMulticastListen function. If it is wished to receive the same multicast traffic on more than one network interface, the IPMulticastListen function is called separately for each network interface.
“multicast-address” is the multicast group address.
“filter-mode” is the network interface mode, which may be INCLUDE or EXCLUDE. In the INCLUDE mode, the network interface defines the source-list as INCLUDE; this means that it wishes to receive the multicast group traffic sent by all the sources in the list. In the EXCLUDE mode, the network interface defines the source-list as EXCLUDE; this means that it wishes to receive the multicast group traffic from all the sources sent in the multicast group, except the sources in the list.
“source-list” is the INCLUDE or EXCLUDE source-list.

For a given socket combination, network interface, and multicast group, there can only be one “filter mode”, which may be INCLUDE or EXCLUDE.

The system stores a state record for each active socket. This register contains the following information:

(interface, multicast-address, filter-mode, {source-list})

For each socket, the “filter-mode” of the record can only be INCLUDE or EXCLUDE.

Likewise, the system stores a state record for each network interface and multicast group. This record contains the following information:

(multicast-address, filter-mode, {source-list})

Each network interface and multicast group has a state record storing the information on the interface and group and the state record contains a field referred to as filter-mode which can only be of the INCLUDE type, containing only INCLUDE sources, or of the EXCLUDE type, containing only EXCLUDE sources. The rules that are transcribed below are applied when the network interface record must result from the combination of different records:
Rule 1. If any of the data sources of a group G1 is EXCLUDE, then the network interface will have an EXCLUDE filter-mode for the group G1 and the source list of the network interface is the intersection of the EXCLUDE source lists minus the sources of the INCLUDE lists.
Rule 2. If all the sources are INCLUDE type sources, then the network interface will have an INCLUDE filter-mode for the group G1 and the source list is the union of all the INCLUDE sources.

The hosts send IGMP messages to the routers via each network interface in order to request multicast traffic, and the content of the messages is typically derived from information in state records associated with given network interface stored in a memory of the computer system.

There are generally two types of events that may cause the host to send IGMP messages to the routers. These are the receipt of an IGMP Query message or a change on the status registers of the network interface caused by, for example, a call to the IPMulticastListen function or other application.

Routers using the IGMP and PIM-SM protocols store the multicast traffic information that they must transmit through each network. This information consists of storing, for each network interface of the router, state information about multicast channels (S,G) or multicast groups (*,G) for which there is at least one host interested in receiving this multicast traffic, with a timer associated to each channel or multicast group that indicates the time passed since the router received the last message requesting this multicast traffic.

Table 1, extracted from RFC 3376, summarizes the operation of a router according to the IGMPv3 protocol. In Table 1, the first column “State 1” shows the initial state of the record of the IGMP router; the second column “Message” shows the content of a Membership Report message received by the IGMP router; the third column “State 2” shows the state of the record of the IGMP router after having received the Membership Report message; the fourth and last column “Actions” shows the actions that the IGMP router carries out after having received the Membership Report message. Table 1 contains 12 rows respectively corresponding to 12 processes which each illustrates the operation of the router according to its initial state (column 1) and according to the messages it has received (column 2).

Table 1 relates to a specific network interface of a router executing the IGMPv3 protocol and to a specific multicast group G. Each network interface and multicast group G will have their own state records which will be affected by the messages that the IGMP router receives through the network interface relating to the group G. The following nomenclature has been used in Table 1:
(A+B) means the union of the sets of sources A and B.
(A*B) means the intersection of the sets of sources A and B.
(A−B) means the set of sources A minus the sources of A that are also found in B.
INCLUDE (A) indicates that the IGMP router has a record with INCLUDE filter-mode with a set of sources A.
EXCLUDE (X,Y) indicates that the IGMP router has a record with EXCLUDE filter-mode because there are EXCLUDE sources, wherein:
   X is the Requested List of EXCLUDE sources
   Y is the Exclude List of EXCLUDE sources.
GMI is a parameter referred to as Group Membership Interval containing a value of time. A value of 260 seconds is used by default.
T (S) is the source timer of source S.
GT is the Group Timer, i.e. the timer of the record for switching from EXCLUDE mode to INCLUDE mode.
SEND Q(G, S) means that the IGMP router sends a Group-And-Source-Specific Query message to the hosts to check if there is still a host interested in receiving the sendings from sources S of multicast group G. When this action is carried out, the IGMP router also reduces the timers of the sources S to the LMQT value. If the IGMP router receives in response a message showing interest in any of the sources S, it then initializes the value of the timers of the sources, for which there is an interested host, to an initial value equal to GMI.
DEL(A) means that the IGMP router deletes from the record the sources of list A.
LMQT is a parameter referred to as Last Member Query Time containing a time value. It is the time a host has to reply to a Group-And-Source-Specific Query type message which has been sent by the IGMP routers. After this time, if no host replies that it is interested in receiving the channels specified in the message, the IGMP router stops transmitting them. The value of LMQT in the IGMPv3 protocol is 20 seconds by default.

The messages in column 2 of Table 1 are the six types of IGMP messages defined in the IGMPv3 protocol for indicating to the router the sources from which it wishes to obtain multicast traffic. The meaning of these six IGMP messages is described in RFC 3376 (chapter 4.2.12) and is as follows:
IS_IN (Z), IS_EX (Z) indicate that the network interface of the host that has sent the message has an INCLUDE or EXCLUDE filter-mode, respectively, for the sources of list Z.
TO_IN (Z), TO_EX (Z) indicate that the network interface of the host that has sent the message has switched the filter-mode from EXCLUDE mode to INCLUDE mode, or from INCLUDE mode to EXCLUDE mode, respectively, for the sources of list Z.
ALLOW (Z) indicates that the network interface of the host that has sent the message wishes to receive the traffic from the new sources of list Z. These sources are the sources that the network interface will add to its INCLUDE source list or they are the sources that it will delete from its EXCLUDE source list.
BLOCK (Z) indicates that the network interface of the host that has sent the message no longer wishes to receive traffic from the sources of list Z. These sources are the sources that the network interface will delete from its INCLUDE source list or they are the sources that it will add to its EXCLUDE source list.

It can be seen that the 12 rows of Table 1 correspond to 12 combinations of an initial state record of the router (column 1) and of a type of IGMP message received (column 2). The router consults the hosts by means of a Group-And-Source-Specific Query message (SEND messages in column 4 of Table 1) for checking if there is a host interested in receiving multicast data from those sources, the traffic of which was being initially transmitted (column 1 of Table 1) and no longer wishes to receive according to the sources indicated in the last received IGMPv3 message (column 2 of Table 1).

The presence of switches on data networks is common, especially in “Local Area Networks” (LAN). A switch is an electronic network interconnection device that normally operates at layer 2 (the data link layer) of the OSI model (“Open Systems Interconnection”). The OSI model is the open systems interconnection reference model created by the ISO (“International Organization for Standardization”) and is known to one skilled in the art.

In computer networking, a “frame” or a “data frame” is a digital data transmission unit on the layer 2 of the OSI model. RFC 1122 defines a frame as “the unit of transmission in a link layer protocol, and consists of a link layer header followed by a packet”

A switch interconnects two or more network segments, passing data frames from one segment to another using the layer 2 destination address of the data frames (for example, the “MAC address” in Ethernet networks). In order to send the data frames to the devices connected to each one of its ports, a switch determines and stores the layer 2 address of each device connected to each of its ports.

The low-level protocol group most used on local area networks is currently the Ethernet protocol group, defined according to IEEE (“Institute of Electrical and Electronics Engineers”) specifications. Ethernet defines both the physical layer (layer 1) and the data link layer (layer 2) in the OSI model, and divides the data link layer into two sublayers: one layer known as LLC (“Logical Link Control”) which is established in the IEEE 802.2 specifications, and a MAC (“Media Access Control”) layer, which is established in the different IEEE 802.3 specifications, such as IEEE 802.3u (“Fast Ethernet”) based on electric cabling, or IEEE 802.3z based on fiber-optics. There are also wireless Ethernet protocols, like IEEE 802.11, also known as WIFI, or IEEE 802.16 known as WIMAX.

The same LLC (Logical Link Control) protocol can be used with different MAC layer protocols since the IEEE establishes new MAC layer protocols without modifying the LLC protocol. This is one of the reasons for the success of Ethernet.

One of the functions of the MAC layer is to determine the physical addresses of the devices. Ethernet uses 6-byte physical addresses referred to as MAC addresses (“Media Access Control Address”).

The IEEE has identified three MAC address categories:
Unicast MAC addresses: these are MAC addresses that identify each individual network interface. Normally the address is determined by the hardware of each network card.
MAC broadcast address: this is the MAC address with 6 bytes having the value FFFF.FFFF.FFFF in hexadecimal format. If a data frame is sent to this address, all the network devices receive the data frame and must process it.
MAC multicast addresses: these are addresses used to transport multicast data packets. When IP protocol is used, a MAC multicast address takes the form 0100.5exx.xxxx in the hexadecimal system, where xx.xxxx may be a value between 00.0000 and 7f.ffff.

Bit 0 of Octet 0 in an IEEE MAC address indicates whether the destination address is broadcast/multicast address or a unicast address. If this bit is set (value=1) then the frame is a broadcast frame or a multicast frame.

In the case of Ethernet IP multicast frames, all of them use MAC layer addresses that begin with the 24 bit prefix 01.00.5E.XX.XX.XX. But only half of these MAC addresses are available for use by IP multicast. This leaves 23 bits of MAC address space for mapping the layer 3 IP multicast address into the layer 2 MAC address.

As there are only 23 bits to determine a MAC multicast address of a data frame, while the IPv4 protocol uses 28 bits to determine an IP multicast address in an IP data packet (the first 4 bits of an IP multicast data packet are always 1110 in binary notation), the 28 bits of the IP multicast address of an IP data packet must be transferred to the 23 bits of the MAC multicast address of the corresponding data frame. Therefore, 5 bits of the IP multicast address are lost in this process. The transfer is therefore made by transferring the 23 least significant bits of the IP multicast address to the 23 bits of the MAC multicast address. Hence, a single MAC multicast address corresponds to 32 IP multicast addresses.

Referring now to FIGS. 4 and 5, different types of layer 2 Ethernet packets or frames encapsulating a layer 3 IP packet are shown.

The preamble of an Ethernet frame consist of a 56-bit (7-byte) pattern of alternating 1 and 0 bits, which allows device on the network to easily detect a new incoming frame.

The Start Frame Delimiter (SFD) is the 8 bit value marking the end of the preamble of an Ethernet frame. It has the value 10101011. The SFD is designed to break the pattern of the preamble, and signal the start of the actual frame. The SFD is immediately followed by the destination MAC address.

Every Ethernet network card has a unique 48-bit serial number called MAC address, which is stored in ROM or EEPROM carried on the card. The MAC address identifies the device uniquely on the LAN.

The destination MAC address (DA) field indicates the MAC address of the network interface of the intended recipient of the packet. The DA field also indicates whether or not the packet contains a multicast or broadcast data. Other fields within the packet may also indicate whether the data is carrying is multicast or broadcast, for example the IP destination address when the payload is a IPv4 packet.

The Source MAC address field provides the identification of the node from which the data packet originated. It identifies the origin node using the MAC address of the network interface of the origin node.

The EtherType is a two octet field indicating the data type encapsulated in the payload (the frame data field). For example, an EtherType value of 0x0800 indicates that the payload contains an IPv4 datagram.

When the original Ethernet standard, developed by DEC, Intel and Xerox, went through a formal IEEE standardization process, the EtherType field was changed to a data length field in the new 802.3 standard. This standard required an IEEE 802.2 header to follow the length field to specify the packet type.

In order to allow packets using different versions of Ethernet framing in the same network, EtherType values must be greater or equal to 1536 (0x0600). That value was chosen because the maximum length of the data field of an Ethernet 802.3 frame is 1500 bytes. If the field's value is greater than or equal to 1536, the field must be an EtherType. If the field's value is less or equal 1500 it must be a length field. Values between 1500 and 1535 are undefined.

FIG. 4 shows an Ethernet packet 420 with a Length field 425. To create a Type field for frames that use the EtherType/Length field as Length field, either one or two additional headers 430 are added after the 802.3 header but before layer 3 header 411. For example, when sending IP packets 410 the Ethernet frame has two additional headers: an IEEE 802.2 Logical Link Control (LLC) header 431 and an IEEE Subnetwork Access Protocol (SNAP) header 432. FIG. 4 shows these additional headers in the field 421. The arrow 427 indicates that the structure of the field 421 is detailed in the element 430. Note that the SNAP header Type 435 has the same purpose, with the same reserved values, as the Ethernet EtherType field. The 802.2 LLC Header 431 comprise the DSAP field (Destination Service Access Point), the SSAP field (Source Service Access Point) and a control field indicated as CTL in FIG. 4. The SNAP Header 432 comprises the OUI field (IEEE Organizationally Unique Identifier) followed by the 2-octet TYPE field that is a protocol identifier like the ETHERTYPE field.

The data portion 422 includes the layer 3 IP packet. In FIG. 4 the data portion 422 is an IP packet 410 comprising an IP Header 411 and IP payload 412. Lines 413 and 414 in FIG. 4 indicate that IP packet 410 is encapsulated in data portion 422.

FIG. 5 shows an Ethernet packet 520 with an EtherType field 525. In this case there are no additional headers with the EtherType field indicating the type of data in the data portion 522. In FIG. 5 the data portion 522 is an encapsulated IP packet 410 as indicated by lines 513 and 514.

The Frame Check Sequence are the extra checksum characters added to a frame for error detection and correction

Although it is not technically correct, the terms packet and frame are sometimes used interchangeably within the art. The IEEE 802.3 standards refer to MAC frames consisting of the destination address, the source address, length/type, data payload and frame check sequence fields. The preamble and the Start Frame Delimiter (SFD) are together considered a header to the MAC frame. This header and the MAC frame are considered a packet.

FIG. 6 illustrates an exemplary multicast data network having three multicast routers, 600, 660 and 650, which receive multicast traffic requests from three hosts, 680, 681 and 682 respectively, using for example the IGMPv3 protocol. The three routers are connected between each other via network 691 using the network interfaces 603, 661 and 651, and use a router-to-router multicast routing protocol, such as PIM-SM, to pass multicast traffic requests between them.

Host 680 has a network interface 683 connected to the network interface 602 of router 600 via the network 692 through which it receives the packets 612 of the multicast channel (S1, G1) requested by host 680.

Host 681 has a network interface 684 connected to the network interface 662 of router 660 via network 694 through which it receives the packets 614 of the multicast channel (S1, G1) requested by host 681.

Host 682 has a network interface 685 connected to the network interface 652 of router 650 via the network 693 through which it receives the packets 633 of the multicast channel (S3, G1) requested by host 682.

Four data sources, namely 610, 620, 630 and 640, transmit multicast traffic in the network 690 connected to the network interface 601 of router 600.

Source 610 transmits packets 611 of the multicast channel (S1, G1) via its network interface 615. S1 is the source IP address of the multicast IP packets transmitted by source 610. Ethernet data frames carrying IP packets 611 have the destination multicast MAC address corresponding to the multicast group G1, and the source MAC address of the network interface 615 of source 610.

Source 620 transmits packets 621 of the multicast channel (S2, G1) via its network interface 625. S2 is the source IP address of the multicast IP packets transmitted by source 620. Ethernet data frames carrying IP packets 621 have the destination multicast MAC address corresponding to the multicast group G1, and the source MAC address of the network interface 625 of source 620.

Source 630 transmits packets 631 of the multicast channel (S3, G1) via its network interface 635. S3 is the source IP address of the multicast IP packets transmitted by source 630. Ethernet data frames carrying IP packets 631 have the destination multicast MAC address corresponding to the multicast group G1, and the source MAC address of the network interface 635 of source 630.

Source 640 transmits packets 641 of the multicast channel (S4, G2) via its network interface 645. S4 is the source IP address of the multicast IP packets transmitted by source 640. Ethernet data frames carrying IP packets 641 have the destination multicast MAC address corresponding to the multicast group G2, and the source MAC address of network interface 645 of source 640.

Multicast router 600 may receive, for example, multicast packets 611, 621, 631 and 641 via its network interface 601.

Router 600 may receive requests for multicast traffic of channel (S1, G1) via its network interface 602 by means of, for example, the IGMPv3 protocol, and may in turn transmit packets 612 of the multicast channel (S1, G1) via the network interface 602.

Router 600 may also receive requests for multicast traffic of channels (S1, G1) and (S3, G1) via its network interface 603 by means of, for example, the PIM-SM protocol, and via the network interface 603 it transmits packets 613 and 632 corresponding to the multicast channels (S1, G1) and (S3, G1).

A problem related to multicast packet transmission occurs when a router receives a multicast packet through a network interface and it does not need to transmit the multicast packet by means of any other network interface of the router according to the router's multicast routing tables. In this case, the router uses processing resources to receive the unwanted multicast packet and discard it. In the example of FIG. 6, the network interface 601 of router 600 receives unwanted multicast traffic from the multicast channels (S2, G1) and (S4, G2).

Implementing a filter that uses the multicast MAC addresses corresponding to the multicast group G2, the network interface 601 may be able to filter all the multicast-group-G2 traffic, including the traffic of the multicast channel (S4, G2), without filtering the traffic of multicast channels (S1, G1) and (S3, G1). This is only possible when the 23 least significant bits of the multicast groups G1 and G2 are different. If the 23 least significant bits of groups G1 and G2 are the same, then it is not possible to distinguish the multicast packets in each group by using only the destination multicast MAC address. In any event, the network interface 601 cannot filter the unwanted multicast traffic from the multicast channel (S2, G1) using only the destination multicast MAC address, since this address is the same MAC address used by the multicast channels (S1,G1) and (S3,G1), which the router wishes to receive.

In co-owned U.S. Pat. No. 7,640,333 entitled “METHOD AND DEVICE FOR MANAGING MULTICAST GROUPS”, filed Feb. 25, 2009, and in U.S. patent application Ser. No. 12/615,163 entitled “METHODS AND DEVICES FOR MANAGING MULTICAST TRAFFIC”, filed Nov. 9, 2009, which are herein incorporated by reference, the named inventor of the present application discloses a number of improvements related to managing multicast traffic. One of these improvements involves storing in a router for each network interface and multicast group address at least one INCLUDE source record at least one EXCLUDE source record.

### SUMMARY OF THE DISCLOSURE

In accordance with one implementation, a method of filtering multicast packets in a third network interface of a router is provided, the router receives multicast traffic from sources that send multicast packets to at least a first multicast group address, the router having a first and a second network interface, the method comprising receiving in the first network interface a first multicast traffic request according to a first multicast routing protocol, the multicast traffic request for the first multicast group address comprising a first set of sources, receiving in the second network interface a second multicast traffic request according to a second multicast routing protocol, the multicast traffic request for the first multicast group address comprising a second set of sources, creating from the first and second multicast traffic requests one or more records comprising a set of sources and which are indicative of all of the sources of the first multicast group address requested to be transmitted through the first and second interfaces of the router; and filtering multicast packets received in the third network interface using the one or more records.

In accordance with another embodiment, a process implemented in a multicast router is provided, the router situated in a data network system between sources that send multicast packets to at least one multicast group address and two or more devices that request data from the at least one multicast group address and one or more of the sources, the multicast router having at least first, second and third network interfaces, the process comprising storing for the first network interface and a first multicast group address one or more first multicast routing protocol state records each comprising a set of sources, the one or more first multicast routing protocol state records derived by data requests made by a first one or plurality devices using a first multicast routing protocol, storing for the second network interface and the first multicast group address one or more second multicast routing protocol state records each comprising a set of sources, the one or more second multicast routing protocol state records derived by data requests made by a second one or plurality devices using a second multicast routing protocol, creating one or more general state records from the first and second multicast routing protocol state records, the one or more general state records each having a set of sources which are indicative of all of the sources of the first multicast group address requested to be transmitted through the first and second network interfaces of the router; and filtering multicast packets received in the third network interface using the one or more general state records.

In accordance with another embodiment, a process implemented in a multicast router is provided, the router situated in a data network system between sources that send multicast packets to at least one multicast group address and two or more devices that request data from the at least one multicast group address and one or more of the sources, the multicast router having at least first, second and third network interfaces, the process comprising storing for the first network interface and a first multicast group address one or more first multicast routing protocol state records each comprising a set of sources, the one or more first multicast routing protocol state records derived by data requests made by a first one or plurality of devices using a first multicast routing protocol, storing for the second network interface and the first multicast group address one or more second multicast routing protocol state records each comprising a set of sources, the second multicast routing protocol state records derived by data requests made by a second one or plurality of devices using a second multicast routing protocol, creating from the one or more second multicast routing protocol state records one or more third state records that are capable of being parsed using the first multicast routing protocol to determine the sources of the first multicast group address requested to be transmitted through the second interface, creating from the one or more first state records and the one or more third state records one or more fourth state records each comprising a set of sources which are indicative of all of the sources of the first multicast group address requested to be transmitted through the first and second interfaces of the router; and filtering multicast packets received in the third network interface using the one or more fourth state records.

In accordance with another embodiment, a process implemented in a multicast router is provided, the router situated in a data network system between sources that send multicast packets to at least one multicast group address and two or more devices that request data from the at least one multicast group address and one or more of the sources, the multicast router having at least first, second and third network interfaces, the process comprising storing for the first network interface and a first multicast group address one or more first multicast routing protocol state records each comprising a set of sources, the one or more first multicast routing protocol state records derived by data requests made by at least a first device using a first multicast routing protocol, storing for the second network interface and the first multicast group address one or more second multicast routing protocol state records each having a set of sources, the one or more second multicast routing protocol state records derived by data requests made by at least a second device using a second multicast routing protocol, creating one or more first general state records each having a set of sources and one or more second general state records each having a set of sources from the first and second multicast routing protocol state records, respectively, the first and second general state records storing in a similar or like manner their respective sets of sources, creating from the first and second general state records one or more third general state records each having a set of sources, the one or more third general state records indicative of all of the sources of the first multicast group address requested to be transmitted through the first and second interfaces of the router; and filtering multicast packets received in the third network interface using the one or more third general state records.

In accordance with another embodiment, a method of filtering multicast packets in a third network interface of a router that receives multicast traffic from sources that send multicast packets to at least a first multicast group address is provided, the router having a first and a second network interface, the method comprising receiving in the first network interface a multicast traffic request according to a first multicast routing protocol, the multicast traffic request for the first multicast address comprising a first set of sources, receiving in the second network interface a multicast traffic request according to a second multicast routing protocol, the multicast traffic request for the first multicast group address comprising a second set of sources, creating a first general state record for the first multicast group address comprising a third set of sources based on the first set of sources, creating a second general state record for the first multicast group address comprising a fourth set of sources based on the second set of sources, creating from the first and second general state records a third general state record for the first multicast group address that comprises a fifth set of sources that is derived from a union or an intersection of the third and fourth set of sources, the fifth set of sources indicative of all of the sources of the first multicast group address requested to be transmitted through the first and second interfaces of the router; and filtering multicast packets received in the third network interface using the third general state record.

In accordance with another embodiment, a method of filtering multicast packets in a third network interface of a router that receives multicast traffic from sources that send multicast packets to at least a first multicast group address is provided, the router having a first and a second network interface, the method comprising receiving in the first network interface a multicast traffic request according to a first multicast routing protocol, the multicast traffic request for the first multicast group address comprising a first set of sources, receiving in the second network interface a multicast traffic request according to a second multicast routing protocol, the multicast traffic request for the first multicast group address comprising a second set of sources, creating a general state record for the first multicast group address comprising a third set of sources that is derived from a union or an intersection of the first and second set of sources, the third set of sources indicative of all of the sources of the first multicast group address requested to be transmitted through the first and second interfaces of the router; and filtering multicast packets received in the third network interface using the general state record.

In one implementation a multicast router is provided that is capable of discarding multicast packets in at least a first network interface of the router and whereby the router creates general multicast status records, which determine all the multicast traffic that the router wants to transmit, and transmits the general multicast status records to the first router interface. The network interface of the router stores in its memory a copy of the general multicast status records, receives an IP multicast packet, and discards the IP multicast packet received if the source and/or destination IP addresses of the IP packet do not correspond to the multicast traffic the router wishes to receive, according to the general multicast status records.

### BRIEF DESCRIPTION OF THE DRAWINGS

Other advantages and features of the present invention can be seen in the following description in which, with a non-limiting character, alternative embodiments are referred to in relation to the attached drawings:

FIG. 1 shows an IGMPv3 Query type message;

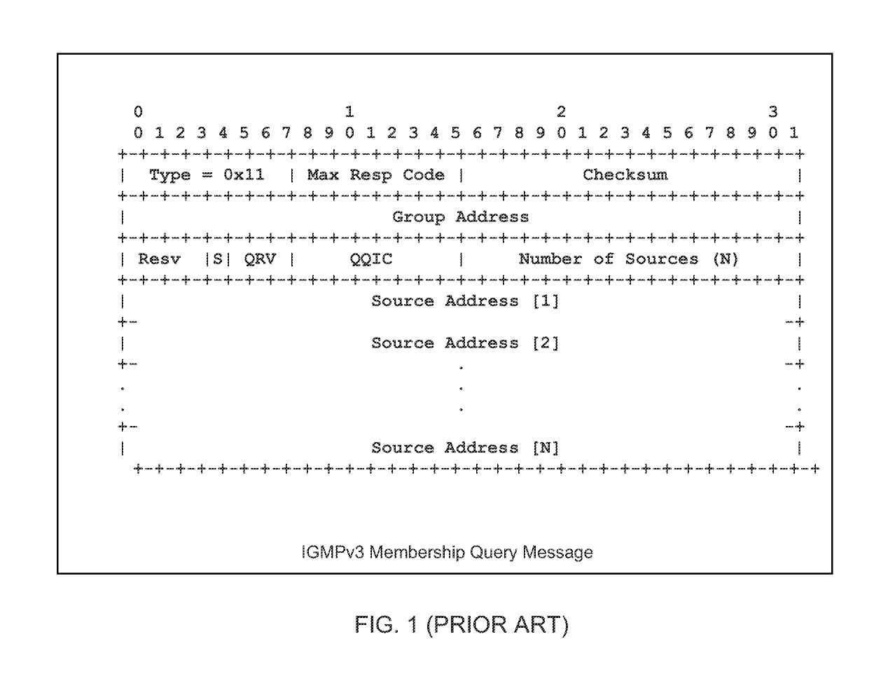

FIG. 2 shows an IGMPv3 Membership Report type message;

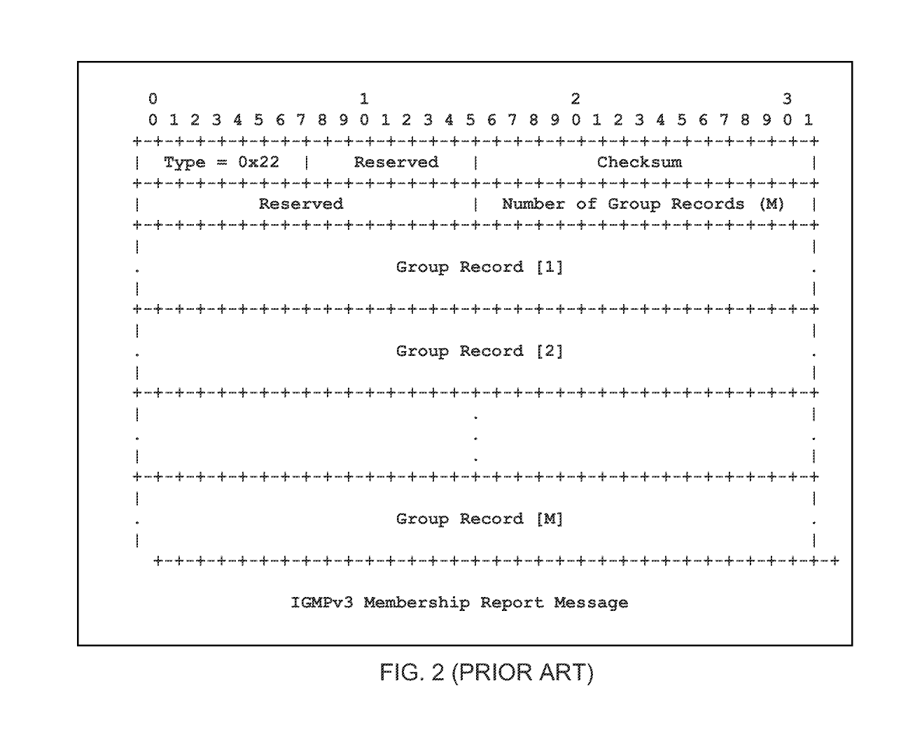

FIG. 3 shows the forming of the “Group Record” blocks contained in IGMPv3 Membership Report type messages;

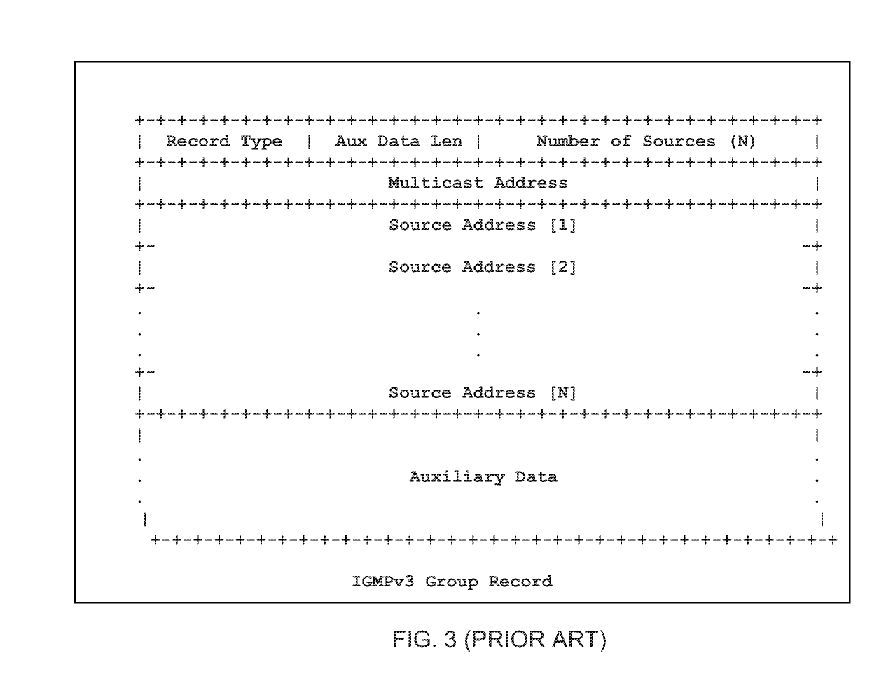

FIG. 4 illustrates a type of Ethernet packet;

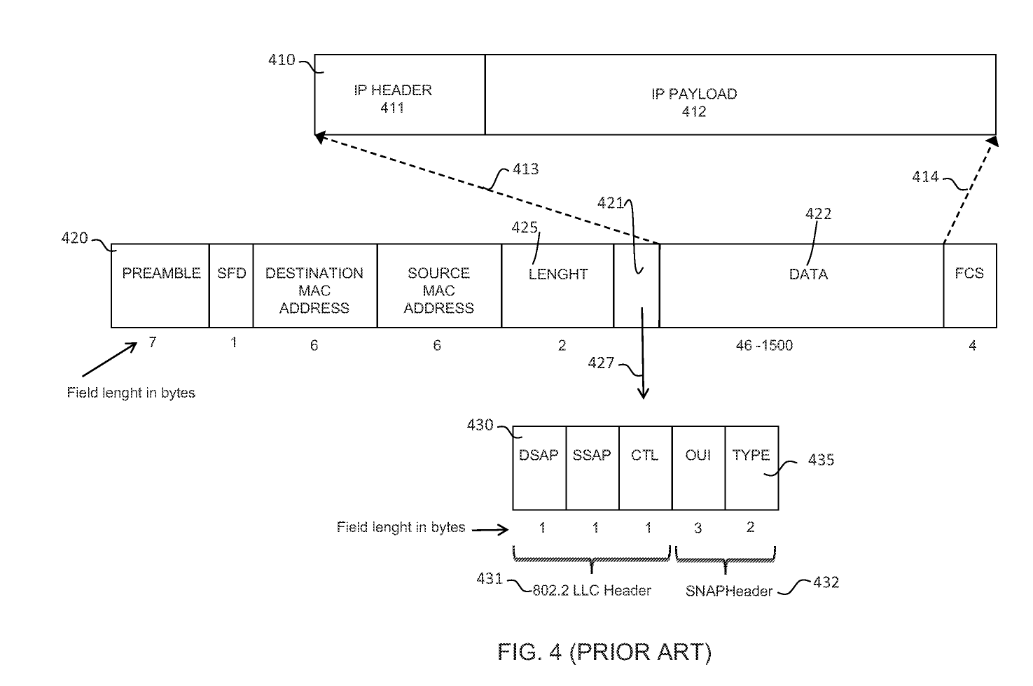

FIG. 5 illustrates another type of Ethernet packet;

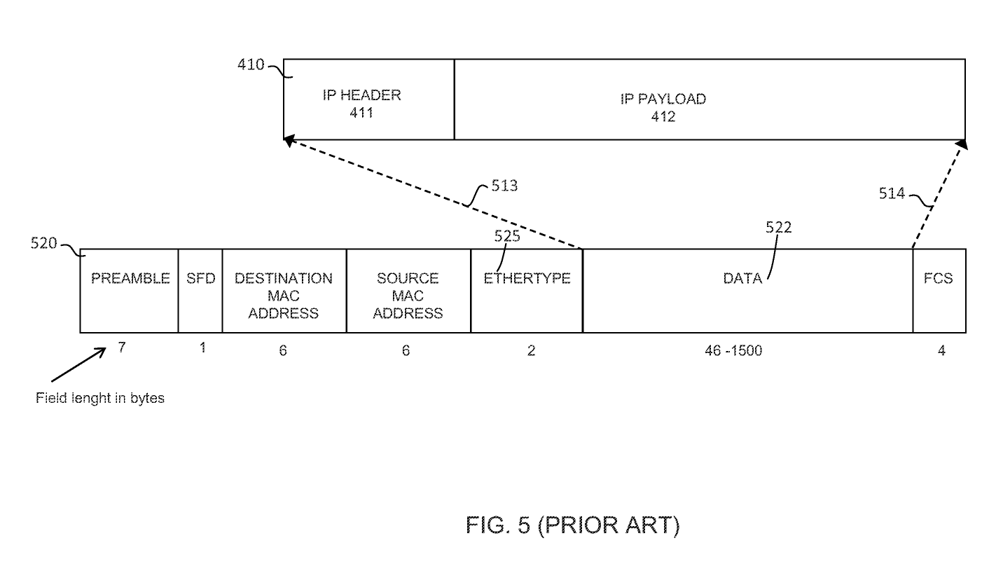

FIG. 6 illustrates an exemplary multicast data network;

FIG. 7 is a block diagram of an exemplary router in one implementation;

FIG. 8 is a block diagram of an exemplary network interface that may implement multicast packet filtering in one implementation;

FIG. 9 is a flow chart that illustrates a multicast IP packet filtering method according to one implementation;

FIG. 10 illustrates another exemplary multicast data network;

FIG. 11 illustrates another exemplary multicast data network.

### DETAILED DESCRIPTION

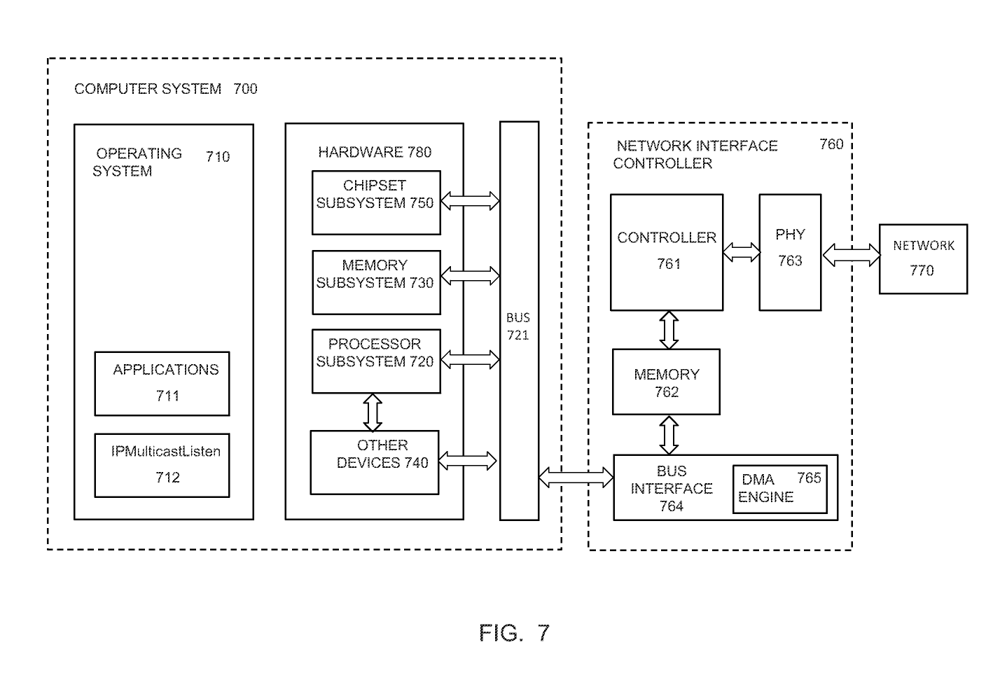

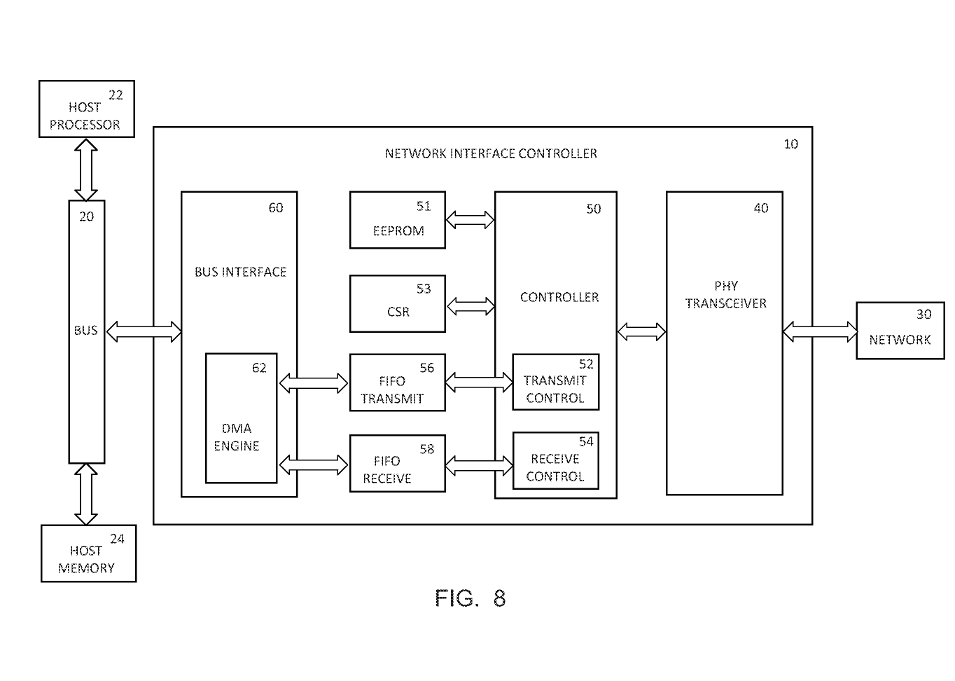

By way of illustration and for exemplary purposes only, FIGS. 7 and 8 are provided to aid in the description of the various implementations disclosed herein. It is to be understood that the computer system/router 700 of FIG. 7 and the network interface 10 of FIG. 8, as illustrated and described herein, represent several of many ways to implement the inventions disclosed herein. In addition, although the following description is based primarily on the IGMP/MLD and the PIM-SM protocols, the various implementations described herein may also be applied to other host-router protocols and other router-router protocols.

FIG. 7 is an example of a router/computing system 700 which can communicate via a network 770 with other computer systems. In one implementation router 700 includes or is otherwise connected to a network interface 760 that communicates with the router 700 via a bus 721. The router 700 includes a processor subsystem 720 which may include a processor, a memory subsystem 730, and a core logic subsystem or chipset 750. The chipset 750 provides bridges among the processor subsystem 720, the router memory subsystem 730 and the bus 721. The router 700 may also include other devices 740 like, for example, a hard disk or a keyboard.

The network interface 760 provides an interface to external networks (e.g., network 770), which may comprise many interconnected computer systems, such as routers and hosts, and communication links. These communication links may be wire line links, optical links, wireless links or any other mechanism for communication of information. In one implementation, network 770 supports an Ethernet protocol. The network interface controller 760 may take the form of a network card that is installed inside the router 700 or it may refer to an embedded component or chip that is a part of the router 700, like for example a component of other devices 740. Network interface 760 may be implemented as a part of chipset of the router 700. FIG. 7 depicts some of the components of the network interface 760 in accordance with one implementation. As shown, the network interface of FIG. 7 includes a controller 761, a PHY 763, a memory 762 and a bus interface 764 having a direct memory access (DMA) engine 765.

The memory subsystem 730 of router 700 may include a number of memories including a main random access memory (RAM) for storage of instructions and data during program execution, and a read only memory (ROM) in which fixed instructions and data are stored. The memory subsystem may also include one or more levels of cache memory. For the sake of simplicity, the router memory subsystem 730 is sometimes referred to herein as “router system memory”. As used herein, virtual memory is considered part of the memory subsystem even though part of it may at times be stored physically on a peripheral device. The memory subsystem 730 contains, among other things, computer instructions which, when executed by the processor subsystem 720, cause the router to operate or perform functions like, for example, the operating systems 710, applications 711 and the IPMulticastListen function 712.

The bus 721 provides a mechanism for allowing the various components and subsystems of router 700 to communicate with each other. In one embodiment the bus 721 comprises a PCI bus. Other embodiments may include other buses, like for example PCI-X or PCI Express, and may also include multiple buses.

Router 700 can be of varying types. Due to the ever-changing nature of computers and networks, the router depicted in FIG. 7 is intended only as an example for purposes of illustrating implementations of the present invention. Many other computer system configurations are possible having more or less components, and configured similarly or differently than those depicted in FIG. 7.

Turning now to FIG. 8, a block diagram of an exemplary network interface 10 in which the present invention may be implemented is shown. It is to be appreciated however, that the various implementations described herein are not limited to any particular type of network interface. The network interface 10 may take any of a variety of forms as discussed above. For example, the network interface 10 may take the form of a network card that is installed inside a router or it may refer to an embedded component of a chip or chipset of a router, or it may be a part of another component, like for example a computer motherboard or an expansion card.

As shown in FIG. 8, in one implementation network interface 10 includes a controller 50, a PHY transceiver 40, various forms of memory 51, 53, 56, 58 and a bus interface 60 comprising a DMA engine 62. The bus interface 60 facilitates communication with a bus 20 of a computer system (such as buses 121 and 721 described above) that has a processor 22 and a memory 24. In the description that follows the terms “computer system” and “router” are used to refer to the device to which the network interface belongs.

In the example of FIG. 8, the network interface 10 is connected to a data network 30 using the PHY transceiver 40. PHY is a common abbreviation for the physical layer of the OSI model. A PHY connects a link layer device (often called MAC) to a physical medium such as, for example, optical fibers or electrically conductive conduits. Information is transmitted to and received from the physical interface through the PHY transceiver 40.

The controller 50 of the network interface 10, which may be a microcontroller or other type of processor, is typically provided to control the transmission and receiving operations of the network interface using appropriate transmit control 52 and receive control 54 programs or state machines. These programs handle the various data control operations required for transmitting and receiving data from a network including, for example, handling error conditions for a collision on the physical medium and retransmitting corrupted data as necessary. In Ethernet networks, for example, most of the functionality desired to implement applicable standards, such as IEEE 802.3, is implemented within the controller 50.

In the network interface of FIG. 8, data coming in and out of controller 50 are buffered in the memory of the network interface by a transmit FIFO 56 and a receive FIFO 58. Communications with the router, including the transmission of data to the bus 20 of the router are managed by the bus interface 60. In the example of FIG. 8, the network interface 10 also includes a CSR (control status registers) block 53 which can provide the control status registers for supporting communication with the router and to store configuration data in the network interface 10. The transmit FIFO 56, receive FIFO 58 and control status registers 53, may be part of the same memory in the network interface 10, or may comprise discrete memory components that include any one of the memories or combinations thereof.

In one implementation, the network 10 also includes an EEPROM 51 which generally includes programming for the controller 50. In one embodiment, EEPROM 51 provides the MAC address (or addresses) assigned to the network interface 10 for use with the computer system/router to which it is coupled.

There are four techniques typically used to transfer data between a peripheral device, such as a network interface, and a processor of a computer system. The transfer of data between a network interface and a computer system may use one or a combination of these techniques. The four techniques are polling, programmed I/O, interrupt-driven I/O and direct memory access (DMA). Direct Memory Access (DMA) is a feature that allows certain hardware components, such as a network interface, associated with a computer system to access the computer system's memory for reading and/or writing with little or no involvement of the computer system's processor. Without DMA, using programmed I/O mode for communicating with peripherals devices, or load/store instructions in the case of multicore chips, the processor of the computer system is typically fully occupied for the entire duration of the read or write operation, and thus unavailable to perform other work. With DMA, the computer system processor can initiate the transfer of data, perform other operations while the transfer is in progress, and receive an interrupt from the DMA controller once the data transfer operation is complete.

In accordance with various implementations of the present invention an improved network interface associated with a router is provided that filters multicast packets in a manner that reduces or obviates altogether the dedication of router processing resources for the purpose of analyzing and discarding unwanted layer 2 and/or layer 3 multicast data packets. A network interfaces of the present invention may be implemented in different ways, such as, for example, using instructions executed in a processor of a network interface card, using an FPGA (Field Programmable Gate Array), or using an application-specific integrated circuit (ASIC). In alternative embodiments, a network interface of the present invention may be implemented within the router itself as a part of the computer system's integrated circuitry. For example, in one embodiment the network interface is implemented as a part of a computer system's chipset.

A limitation of the current state-of-the-art network interface controllers is that they implement multicast filtering using layer 2 addresses of the frames, for example Ethernet MAC addresses. This has some limitations because when multicast data packets pass through a router, the Level 2 addresses cannot be associated with source IP addresses of the data source transmitting IP multicast packets.

When using source-specific multicast, multicast traffic cannot be filtered using only the link layer or layer 2 addresses, because in source-specific multicast technology a parameter that is used to indicate the desired multicast traffic is the IP address of the multicast data source, and this information is not stored in the header of the frames carrying IP packets but in the header of the IP packets.

Another limitation of the current state-of-the-art is that a multicast MAC address corresponds to 32 IP multicast addresses, so that it is not possible to filter only part of the 32 IP multicast addresses using layer 2 addresses. Under the current state-of-the-art, either all 32 IP addresses corresponding to a layer 2 address are filtered or none of the 32 IP addresses are filtered at all.

Another limitation of current router multicast packet filtering methods is that the filters implemented in the network interface controllers enable the filtering of packets using the destination link layer addresses or the source link layer addresses, but not both at the same time to filter a single frame.

One way of filtering multicast packets that have not passed through a router is to establish a relationship between the source link layer addresses and the source IP addresses by using, for example, the Address Resolution Protocol (ARP). ARP, understood by those skilled in the art in the relevant field and not explained here, makes it possible to associate the IP address (Layer 3) of a device with the link layer address (layer 2) of its network interface.

This relationship between Layer 2 and Layer 3 source addresses, obtained for example through ARP, can be used to filter unwanted multicast traffic in a network interface on a computer, if the network interface uses the Layer 2 source and destination addresses to perform the filtering. When using the source and destination addresses of the frame, it is possible to filter multicast traffic from a specific data source for a given multicast group, but only when the packets have not gone through a router.

When, by means of a network interface, a router receives a data frame carrying an IP packet, either with a unicast or a multicast destination address, the router removes the frame header and transmits the IP packet by another or other network interfaces. In general, the routing process only transmits the IP packets and discards the headers of the data frames and the trailers in the process.

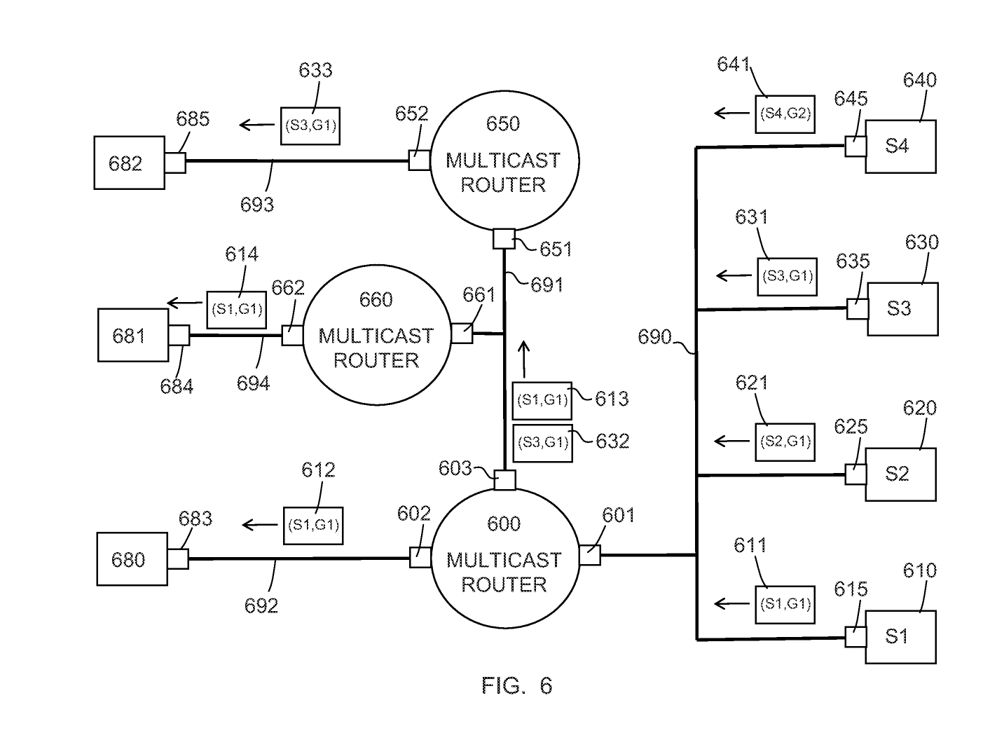

FIG. 6 shows these problems and helps to explain different solutions offered by different embodiments of the present invention. Although the explanation of the present invention is partly based on the IGMP protocol, the present invention is equally applicable to the MLD protocol, or any other multicast routing protocol adaptable to one or more of the filtering implementations disclosed or contemplated herein. The examples in FIG. 6 are explained using MAC-type link layer addresses, although the present invention is equally applicable to other types of layer 2 addresses.

As shown in FIG. 6, the network interface 601 of router 600 receives the unwanted multicast traffic from the multicast channels (S2,G1) and (S4,G2). With a state-of-the-art filter that uses the multicast MAC addresses corresponding to the multicast group G2, the network interface 601 would be able to filter all the multicast-group-G2 traffic, including the traffic of the multicast channel (S4,G2), without filtering the traffic of multicast channels (S1,G1) and (S3,G1), which router 600 does need to receive and process in order to relay. This is only possible when the 23 least significant bits of the multicast groups G1 and G2 are different. If the 23 least significant bits of groups G1 and G2 are the same, then it is not possible to distinguish the multicast packets in each group by using only the destination multicast MAC address.

However, the network interface 601 cannot filter the unwanted multicast traffic from the multicast channel (S2,G1) using only the destination multicast MAC address, since this address is the same MAC address used by the multicast channels (S1,G1) and (S3,G1), which the router does want to receive.

In one implementation of the present invention, network interface 601 is able to filter packets 621 of the multicast channel (S2,G1), filtering those data frames with a destination multicast MAC address corresponding to group G1, and a source unicast MAC address of the network interface 625 of host 620, which is the source emitting the multicast channel (S2,G1). Thus the network interface 601 is able to filter those packets 621 that it does not wish to receive without filtering packets 611 and 631, which it desires to receive. As explained above, the network interface 601 may determine the unicast MAC address corresponding to the network interface 625 by using, for example, the ARP protocol. However, this process is only applicable to network 690, because when the IP packets go through the router 600, the information of the unicast MAC address of the network interface 625 is lost.

IP packets 613 of the multicast channel (S1,G1), transmitted through the network interface 603, are carried in Ethernet data frames with a destination multicast MAC address corresponding to the multicast group G1, and a source unicast MAC address corresponding to the network interface 603 of router 600.

IP packets 632 of the multicast channel (S3,G1), transmitted through the network interface 603, are carried in Ethernet data frames with a destination multicast MAC address corresponding to the multicast group G1, and a source unicast MAC address corresponding to the network interface 603 of router 600.

Therefore, in network 691, Ethernet data frames that encapsulate IP packets 613 and 632 use the same source and destination MAC addresses, although carrying IP packets from different multicast channels, and it is not possible to use the source and/or destination MAC addresses to filter one of said multicast channels without filtering them both. During the routing process in router 600, information of the source unicast MAC address of network interfaces 615 and 635 that has been lost, which was in the frames carrying packets 611 and 631, respectively, that reach the network interface 601 of router 600.

Router 660 wishes to receive, via its network interface 661, multicast packets 613 of the multicast channel (S1,G1) requested by the host 681, but it does not want to receive the packets 632 of the multicast channel (S3, G1).

Router 650 wishes to receive, via its network interface 651, multicast packets 632 of the multicast channel (S3,G1) requested by the host 682, but it does not want to receive the packets 613 of the multicast channel (S1,G1).

In one implementation of the present invention, the network interfaces of the routers 600, 660 and 650 filter multicast data packets using the source and/or destination IP addresses of the multicast IP packets instead of using MAC addresses. In one implementation status records are used to transmit to each network interface of the router information about the multicast traffic that the router wishes to receive.

In one implementation of the present invention, the network interface controller 50 filters the multicast traffic using multicast status records comprising multicast traffic information that the router wishes to receive, in order to filter the multicast traffic that the router does not want to receive.

Multicast routers may use different multicast routing protocols, such as IGMPv3 and PIM-SM, and each of these multicast routing protocols may store different types of records to indicate the multicast traffic to be transmitted by the router. As discussed above, the present invention is not restricted to the IGMP, MLD or PIM-SM protocols, but instead is applicable for use with any host-router protocol and/or router-router protocol adaptable to one or more of the filtering implementations disclosed or contemplated herein.

In one embodiment of the present invention, a router uses general multicast status records that may be created using a variety of multicast protocols, that is, not dependent on whether the multicast protocol applied by the router is a host-router communication protocol (e.g., IGMP), a router-router communication protocol (e.g., PIM-SM protocol) or any other multicast protocol. Moreover, a router of the present invention may likewise use other multicast status records that are specific for each multicast routing protocol, and also use general multicast status records which determine all the multicast traffic that the router wishes to receive, considering all the multicast routing protocols implemented by the router.

In the multicast status records of the different multicast routing protocols, a router according to one implementation stores the multicast traffic to be transmitted via each network interface. However, to decide whether the router wishes to receive a multicast packet, for example because it needs to transmit it by one of its network interfaces, all the multicast status records of all the network interfaces and all the multicast routing protocols are taken into account. In such an implementation the general multicast status records jointly store the information of all multicast traffic that the router wishes to receive, and are different from the status records of the different multicast routing protocols which separately store the multicast traffic information that the router must transmit via each network interface for each multicast routing protocol and for each network interface of the router. In one implementation, for each network interface and multicast group address the router stores both an INCLUDE multicast state record and an EXCLUDE multicast state record. In such an implementation, in the event that all multicast traffic request received in a network interface comprise only include source lists, only an INCLUDE source record is maintained for the network interface and multicast group address. Likewise, in the event that all multicast traffic request received in a network interface comprise only exclude source lists, only an EXCLUDE source record is maintained for the network interface and multicast group address.

A structure of the general multicast status records may be as follows:

INCLUDE type record: (multicast-address, filter-mode=INCLUDE, {source-list})
EXCLUDE type record: (multicast-address, filter-mode=EXCLUDE, {source-list})

### Where:

“multicast-address” is the multicast group IP address.
“filter-mode” can be INCLUDE or EXCLUDE. INCLUDE mode indicates that the “source-list” of the record is an INCLUDE source-list, meaning that the router wishes to receive the multicast traffic transmitted by the sources of that list. The EXCLUDE mode indicates that the “source-list” is an EXCLUDE source-list, meaning that the router wants to receive the multicast traffic transmitted by all emitting sources in the multicast group, except the sources of that list.
“source-list” is a list of IP addresses.
In one implementation, for each multicast group address the router stores both an INCLUDE general multicast status record and an EXCLUDE general multicast status record. In such an implementation, in the event that all multicast traffic request received in the router for a multicast group comprise only include source lists, only an INCLUDE general multicast status record is maintained for the multicast group address. Likewise, in the event that all multicast traffic request received in the router comprise only exclude source lists, only an EXCLUDE general multicast status record is maintained for the multicast group address.

By means of the general multicast status records, the router can store information related to the multicast traffic information requested through all of its network interfaces. In accordance with various implementations, the general multicast status records make it possible to define the multicast traffic the router wishes to receive in a manner that is common for all or a variety of routing protocols.

By using two records for each multicast group address, one with an INCLUDE “filter-mode” and another with an EXCLUDE “filter-mode”, it is possible to store the information pertaining to all the requests for IGMP protocol multicast traffic and also the information corresponding to the following types of PIM-SM protocol messages: “(S,G) JOIN/PRUNE”, “(*,G) JOIN/PRUNE” and “(S,G,rpt) JOIN/PRUNE”. As noted above, in some implementations only an INCLUDE type source record or an EXCLUDE type source record is needed.

Hereunder it is explained how to store, in general multicast status records, the information from the records that the router uses to store the multicast traffic information requested by means of the IGMPv3 protocol. However, it is important to note that the present invention is not limited to IGMPv3 or any particular type of communications protocol.

For a given network interface and a given multicast group, the IGMPv3 router stores the multicast traffic information using an INCLUDE (A) record or an EXCLUDE (X,Y) record, where A is a set of include sources, X is the requested list (sources whose timer has a value greater than zero) and Y is the exclude list (sources whose timer value is equal to zero). The correspondence between the IGMPv3 records and general multicast status records in one example is the following:

| IGMPv3 Record | General multicast status record |
|---|---|
| INCLUDE (A) | (filter mode = INCLUDE, source list = A) |
| EXCLUDE (X, Y) | (filter mode = EXCLUDE, source list = Y) |

In the above example, a router of the present invention creates general multicast status records based on the status records used by the IGMPv3 protocol. However, other embodiments are possible and a router of the present invention can create general multicast status records using multicast routing messages or the macros used by the multicast routing protocols as described below using as an example the PIM-SM protocol.

The messages sent by a PIM-SM router are explained in section 4.5 of RFC 4601. In the PIM-SM protocol, the correspondence between the messages “(S,G) JOIN/PRUNE”, “(*,G) JOIN/PRUNE” and “(S,G,rpt) JOIN/PRUNE” of the PIM-SM protocol and the general multicast status records are described below.

The JOIN(S,G) type PIM-SM message corresponds to a general multicast status record with an INCLUDE “filter-mode” referred to group G and source S. If the router receives a PRUNE(S,G) message, it removes source S from the INCLUDE “source-list” of said record with an INCLUDE “filter-mode”.

The JOIN (*,G) type PIM-SM message corresponds to a general multicast status record with an EXCLUDE “filter-mode” referred to group G and an empty “source-list”. If the router receives a PRUNE(*,G) message, it removes that record with an EXCLUDE “filter-mode”.

The PRUNE (S,G,rpt) type PIM-SM message corresponds to a general multicast status record with an EXCLUDE “filter-mode” referred to group G and which includes source S in the EXCLUDE “source-list”. If the router receives a JOIN(S,G,rpt) message, it removes source S from the “source-list” of the record with an EXCLUDE “filter-mode”.

The PIM-SM protocol also uses a series of macros that are defined in section “4.1.6 State Summarization Macros” of RFC 4601. These macros are used in PIM-SM protocol state machines.

Other implementations of the present invention may use some of these macros to create or modify general multicast status records, such as the so-called pim_include (*,G), pim_include (S,G) and pim_exclude (S,G) macros that are defined in the RFC 4601 as follows:

```
pim_include(*,G) =
      { all interfaces I such that:
              ( ( I_am_DR ( I ) AND lost_assert(*,G,I) == FALSE )
                    OR AssertWinner(*,G,I) == me )
              AND local_receiver_include(*,G,I) }
pim_include(S,G) =
        { all interfaces I such that:
              ( ( I_am_DR ( I ) AND lost_assert(S,G,I) == FALSE )
                    OR AssertWinner(S,G,I) == me )
              AND local_receiver_include(S,G,I) }
pim_exclude(S, G) =
        { all interfaces I such that:
              ( ( I_am_DR ( I ) AND lost_assert(*,G,I) == FALSE )
                    OR AssertWinner(*,G,I) == me )
              AND local_receiver_include(S,G,I) }
```

The aforementioned paragraph 4.1.6 of RFC 4601 gives a detailed description of how these macros work, however, a summary is provided below.

The pim_include (*,G) macro contains the set of network interfaces of the PIM-SM router through which all multicast group G traffic must be sent.

The pim_include (S,G) macro contains the set of network interfaces of the PIM-SM router through which all multicast channel (S, G) traffic must be sent.

The pim_exclude (S,G) macro contains the set of network interfaces of the PIM-SM router through which all the multicast group G traffic must be sent, except the group G multicast traffic coming from source S.

In alternative implementations general multicast status records created from these macros may take the following forms:

| PIM-SM Macro | General multicast status record |
|---|---|
| Pim_include (*, G) | (multicast address = G, |
| | filter mode = EXCLUDE, source list = { }) |
| Pim_include (S, G) | (multicast address = G, |
| | filter mode = INCLUDE, source list = {S}) |
| Pim_exclude (S, G) | (multicast address = G, |
| | filter mode = EXCLUDE, source list = {S}) |

When, in a multicast group, there is a general multicast status record with data sources from more than one protocol and/or more than one network interface of the router (e.g. from the IGMPv3 and PIM-SM protocols), if the multicast status record is an INCLUDE record, then its include source-list contains the union of the include source-lists from the different protocols and/or network interfaces (e.g. the union of include source-lists derived from the IGMPv3 and PIM-SM protocols and/or the union of include source-lists from two network interfaces). If the multicast status record is an EXCLUDE record, its source-list contains the intersection of the exclude source-lists from the different protocols and/or network interfaces (e.g. the intersection of the exclude source-lists from the IGMPv3 and PIM-SM protocols and/or the intersection of the exclude source-lists of two network interfaces.)

Hence, in alternative implementations a router of the present invention stores general multicast status records which determine all the multicast traffic that the router wishes to receive through all its network interfaces.

In one implementation of the present invention, a router can be configured to always receive certain types of multicast traffic. For example, the multicast group 224.0.0.1, known as “all systems multicast address”, is used by the IGMPv3 protocol as the destination IP address of IP packets carrying Membership Report-type IGMPv3 messages, and therefore the router of the present invention may be interested in always receiving traffic from this multicast group. To this end the router may create or add a general multicast status record for specific multicast groups, such as the multicast group 224.0.01, with an EXCLUDE filter mode and an empty source-list. By using different general multicast status records with an INCLUDE or EXCLUDE filter mode, the router can be configured to always receive multicast traffic from specific multicast channels or multicast groups.

In one implementation of the present invention, a router transmits or stores a copy of the general multicast status records to each of its network interfaces. The network interfaces store this information in their own memories and can thus filter multicast traffic that the router does not want to receive. The transmission of general multicast status records from the router memory to network interfaces can be performed using any of the communication procedures between a computer system and its network interfaces, for example, by using DMA or memory mapped I/O.

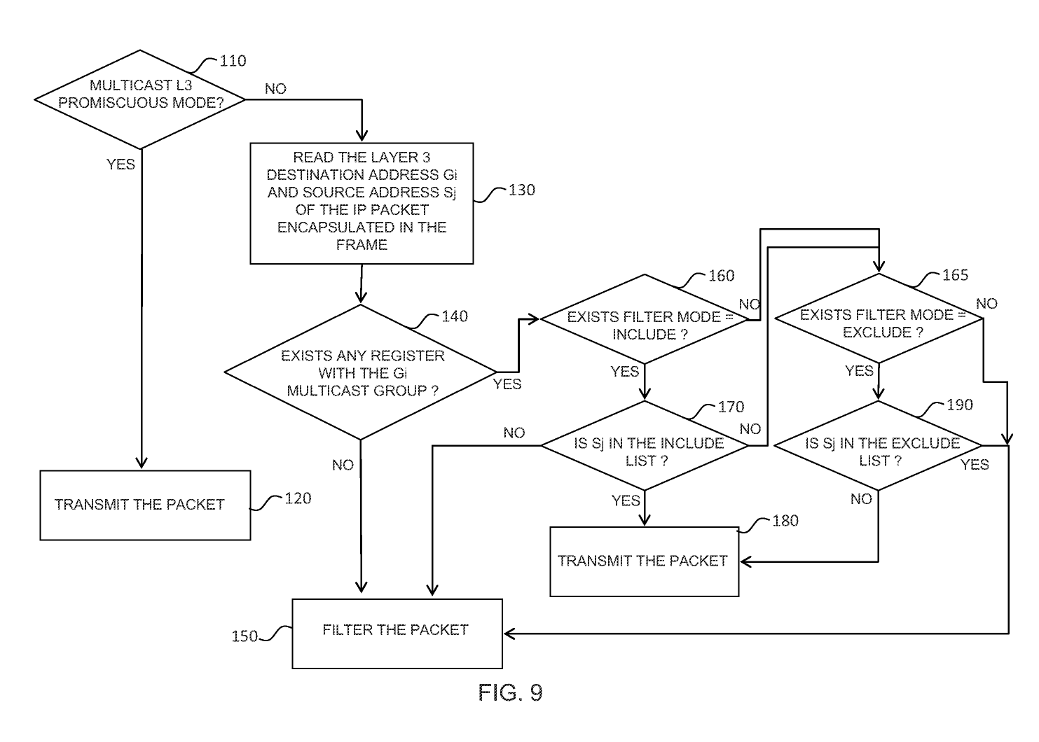

In one implementation each network interface of the router is able to filter multicast data packets it receives using the general multicast status records of the router. For example, FIG. 9 shows an example of multicast packet filtering method in one implementation which uses the source and/or destination IP addresses. In the example of FIG. 9, the network adapter has two different modes: the promiscuous mode and the filter mode. The network adapter checks its status in step 110. If the network adapter is in promiscuous mode, the network interface transmits all multicast packets received in step 120. If the network adapter is not in promiscuous mode, a filtering process is implemented. In step 130, the network adapter reads the destination address G1 (multicast group address) and the source IP address Sj of the IP packet. In step 140, the network adapter checks whether it has any general multicast status records with the G1 multicast group address. If no records for the G1 multicast group address exist, the network adapter filters the packet in step 150, because the router does not want G1 multicast group address packets. Otherwise, that is, if there is a general multicast status record or records for the G1 multicast group address, the process follows to step 160. In step 160, the network adapter checks if there is a general multicast status record for the G1 multicast group address with an INCLUDE-type filter-mode. If there is a status record with an INCLUDE filter mode, the network adapter, at step 170, checks if the source Sj of the IP packet is included in the include source-list of the status record. If the source Sj is in the INCLUDE list, the router wants to receive that packet and the network interface controller transmits the packet in step 180, so it may be processed by the router. If the source Sj is not in the include source-list, the process continues at step 165. In step 165, the network adapter checks if there is a general multicast status record for the multicast group address G1 with an EXCLUDE-type filter-mode. If there is no record, the process follows to step 150, filtering the multicast data packet. If there is a general multicast status record with an EXCLUDE filter mode for the G1 multicast group, the process, in step 190, checks if the Sj source is included in the exclude source-list of such record. If it is not, the process moves to step 180 and the multicast packet is transmitted to the router. If it is, that is, if the Sj source is included in the EXCLUDE record, the process moves to step 150 and filters the multicast data packet.

In another implementation, multicast packets are filtered by a first network interface of a router having at least the first network interface and also second and third network interfaces, the router situated to receive multicast traffic from sources that send multicast packets to at least a first multicast group address. For purpose of illustration, reference is made to router 600 shown in FIG. 6. As illustrated, router 600 has a first network interface 601 situated to receive multicast traffic from sources 610, 620, 630 and 640. Router 600 also has a second network interface 602 that communicates with host 680 via a host-router protocol. A third network interface 603 is also provided that facilitates communication between router 600 and routers 650 and 660 via a router-router protocol. In one implementation the second network interface 602 receives a first multicast traffic request from host 680 for the multicast group address G1 comprising a first set of sources S1, and the third network interface receives second and third multicast traffic request from router 650 and router 660 to request multicast traffic for the multicast group address G1 from sources S1 and S3, respectively. In one implementation, router 600 creates from the first, second and third multicast traffic requests one or more records having a set of sources indicative of all of the sources of the multicast group address G1 requested to be transmitted through the second and third network interfaces 602, 603 of router 600 and uses these one or more records to filter multicast packets received in the first network interface 601. This may be accomplished in a variety of ways. As discussed above, the router 600 may create one or more general multicast filter state records directly from the multicast traffic request received in interfaces 602 and 603, or indirectly by first creating intermediary general multicast state records representative of each multicast traffic request and using the intermediary general multicast state records to create the one or more general multicast filter state records, and use these one or more general multicast filter state records to filter multicast packets received in the first network interface 601.

In an alternative implementation, in lieu of creating one or more general multicast state records, router 600 and/or interface 603 converts the router-router multicast traffic requests into a format where it/they may be parsed in a like or similar manner to the host-router multicast traffic request received at interface 602. In one implementation, a router-router protocol multicast traffic request received at network interface 603 is transformed to have an identical or similar structure to the host-router protocol multicast traffic request received at network interface 602. It is important to note that the format need not be identical to the host-router protocol multicast traffic request. In one implementation the router-router protocol multicast traffic requests are transformed, or otherwise adapted to have the ability to be parsed using the host-router protocol to determine the set of sources being requested through network interface 603 In one implementation, router 600 uses the host-router protocol to parse all the traffic requests (from the hosts and the routers) in order to create one or more state records that may be used to filter multicast packets received at network interface 601. In an exemplary example, the host-router protocol is a version of the IGMP or MLD protocol and the router-router protocol is a version of the PIM-SM protocol.

In accordance with one implementation, a router 600 comprises computer executable instructions that when executed (a) store for the second network interface 602 and a multicast group address (e.g., G1) one or more host-router protocol state records each comprising a set of sources, (The host-router protocol state records may be derived by data requests made by one or plurality hosts and/or proxies), (b) stores for the third network interface and the multicast group address (e.g., G1) one or more router-router protocol state records each comprising a set of sources. (The router-router protocol state record may be derived by data requests made by one or plurality of routers.), (c) create from the one or more router-router protocol state records one or more modified state records that are capable of being parsed using the host-router protocol to determine the sources of the multicast group address (e.g, G1) requested to be transmitted through the third network interface 603, (d) create from the one or more host-router protocol state records and modified state records one or more filter state records comprising sets of sources indicative of all of the sources of the multicast group address (e.g., G1) requested to be transmitted through the second and third network interfaces; and (e) filter multicast packets received in the first network interface 601 using the one or more filter state records.

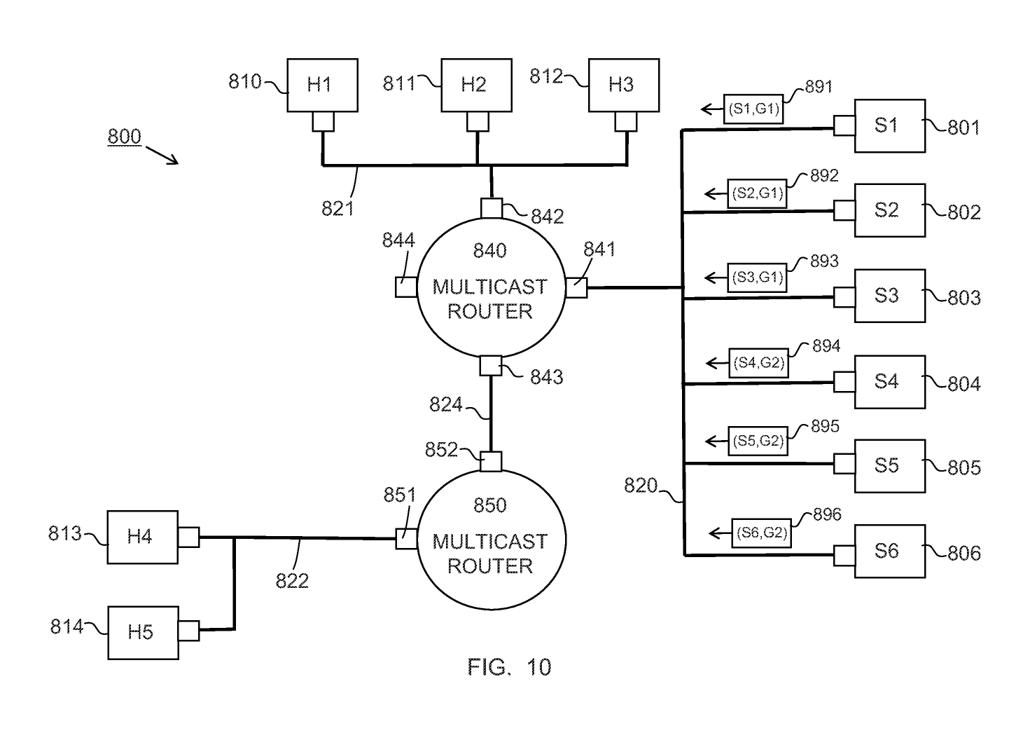

A first illustrative example of an implementation of the present invention will now be explained in conjunction with the exemplary multicast data network 800 depicted in FIG. 10. Network 800 includes two routers 840 and 850 which communicate with one another via network 824 interposed between their respective network interfaces 843 and 852. Communication between routers 840 and 850 is facilitated by the use of a router-to-router multicast routing protocol, such as PIM-SM.

Router 840 receives multicast traffic requests directly from three hosts 810, 811 and 812. The multicast traffic requests are sent from the hosts 810, 811, 812 from their respective network interface via network 821 to the network interface 842 of router 840. Router 850 receives multicast traffic requests from two hosts 813 and 814. The multicast traffic requests are sent from the host 813, 814 from their respective network interface via network 822 to the network interface 851 of router 850. Communication between routers 840 and 850 and the hosts requesting multicast traffic is facilitated by the use of a host-to-router multicast routing protocol, such as IGMPv3.

Six data sources, 801-806 transmit multicast traffic in the network 820 connected to the network interface 841 of router 840. S1, S2, S3, S4, S5 and S6 are the source IP addresses used by the data sources 801-806 respectively. Source 801 transmits packets 891 of the multicast channel (S1,G1). Source 802 transmits packets 892 of the multicast channel (S2,G1). Source 803 transmits packets 893 of the multicast channel (S3,G1). Source 804 transmits packets 894 of the multicast channel (S4,G2). Source 805 transmits packets 895 of the multicast channel (S5,G2). Source 806 transmits packets 896 of the multicast channel (S6,G2).

In accordance with the first illustrative example, host 810 sends to router 840 an EXCLUDE (G1, {S1,53}) type membership message having a set of sources 51 and S3 indicating that it wishes to receive multicast traffic from all sources except the sources 51 and S3 of multicast group address G1. Host 811 sends to router 840 an EXCLUDE (G1, {S1}) type membership message having a set of sources 51 indicating that it wishes to receive multicast traffic from all sources except source 51 of multicast group address G1. Host 812 sends to router 840 an EXCLUDE (G2, {S5}) type membership message having a set of sources S5 indicating that it wishes to receive multicast traffic from all sources except source S5 of multicast group address G2. Host 813 sends to router 850 an INCLUDE (G2, {S6}) type membership message having a set of sources S6 indicating that it wishes to receive multicast traffic only from source S6 of multicast group address G2. Host 814 sends to router 850 an INCLUDE (G1, {S1}) type membership message having a set of sources 51 indicating that it wishes to receive multicast traffic only from source 51 of multicast group address G1.

As a result of having received the multicast traffic request from hosts 810, 811 and 812, router 840 may create directly from the requests general multicast state records for network interface 842 that include a first record (G1, EXCLUDE {S1}) and a second record (G2, EXCLUDE {S5}). In an alternative implementation router 840 may first create one or more IGMPv3 group records and then create from the one or more group records the general multicast state records.

As a result of having received the multicast traffic request of hosts 813 and 814, router 850 sends from network interface 852 to the network interface 843 of router 840 a PIM-SM JOIN (S1,G1) message and also a PIM-SM JOIN (S6, G2) message. In return, router 840 creates for network interface 843 a first general multicast state record (G1, INCLUDE {S1}) and a second general multicast state record (G2, INCLUDE {S6}).

Thus, router 840 will have stored four general multicast state records which are used to filter unwanted multicast packets received at network interface 841. The four records being in a form that includes the following information (G1, INCLUDE {S1}); (G1, EXCLUDE {S1}); (G2, INCLUDE {S6}) and (G2, EXCLUDE {S5}). It is important to note here that the general multicast state records of the present invention are in no way limited to any particular structure. It is only important that the records are capable of being parsed to extract the relevant multicast group address and source address information that enables them to be used to filter multicast packets received in a network interface of a router.

Turning now to FIG. 9, and assuming that the network interface 841 is not in promiscuous mode, network interface 841 systematically reads and compares the destination and source address of the IP packets received in the interface with registers/records comprising the information of the four general multicast state records in a manner consistent with the process shown in FIG. 9. It is important to note that the process of FIG. 9 is only one of various methods that may be executed to filter IP packets at interface 841. In any event, in the current example, by virtue of the information store in router 840, network interface 841 will transmit all IP packets through the network interface except those packets having a destination address G2 and a source address S5.

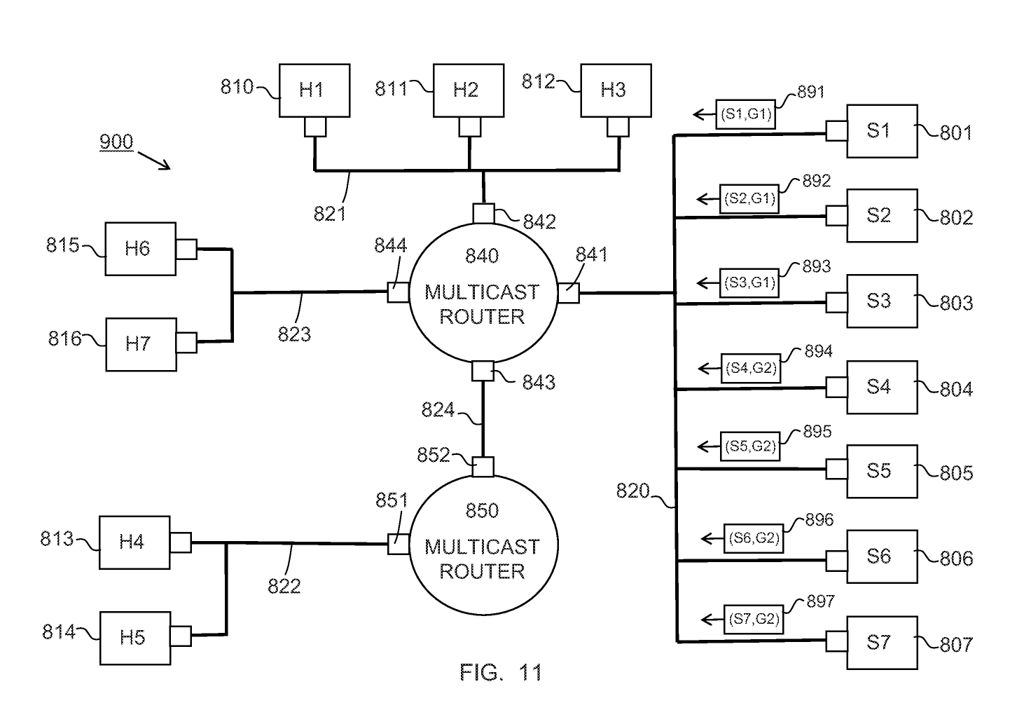

A second illustrative example of an implementation of the present invention will now be explained in conjunction with the exemplary multicast data network 900 depicted in FIG. 11. Network 800 includes two routers 840 and 850 which communicate with one another via network 824 interposed between their respective network interfaces 843 and 852. Communication between routers 840 and 850 is facilitated by the use of a router-to-router multicast routing protocol, such as PIM-SM.

Router 840 receives multicast traffic requests directly from five hosts 810, 811, 812, 815 and 816. The multicast traffic requests are sent from the hosts 810, 811, 812 from their respective network interface via network 821 to the network interface 842 of router 840. The multicast traffic requests are sent from the hosts 815, 816 from their respective network interface via network 823 to the network interface 844 of router 840. Router 850 receives multicast traffic requests from two hosts 813 and 814. The multicast traffic requests are sent from the host 813, 814 from their respective network interface via network 822 to the network interface 851 of router 850. Communication between routers 840 and 850 and the hosts requesting multicast traffic is facilitated by the use of a host-to-router multicast routing protocol, such as IGMPv3.

Seven data sources, 801-807 transmit multicast traffic in the network 820 connected to the network interface 841 of router 840. S1, S2, S3, S4, S5, S6 and S7 are the source IP addresses used by the data sources 801-807 respectively. Source 801 transmits packets 891 of the multicast channel (S1,G1). Source 802 transmits packets 892 of the multicast channel (S2,G1). Source 803 transmits packets 893 of the multicast channel (S3,G1). Source 804 transmits packets 894 of the multicast channel (S4,G2). Source 805 transmits packets 895 of the multicast channel (S5,G2). Source 806 transmits packets 896 of the multicast channel (S6,G2). Source 807 transmits packets 897 of the multicast channel (S7,G2).

In accordance with the first illustrative example, host 810 sends to router 840 an EXCLUDE (G1, {S1,S3}) type membership message having a set of sources S1 and S3 indicating that it wishes to receive multicast traffic from all sources except the sources S1 and S3 of multicast group address G1. Host 811 sends to router 840 an EXCLUDE (G1, {S1}) type membership message having a set of sources S1 indicating that it wishes to receive multicast traffic from all sources except source S1 of multicast group address G1. Host 812 sends to router 840 an EXCLUDE (G2, {S5,S7}) type membership message having a set of sources S5 and S7 indicating that it wishes to receive multicast traffic from all sources except sources S5 and S7 of multicast group address G2. Host 813 sends to router 850 an INCLUDE (G2, {S6}) type membership message having a set of sources S6 indicating that it wishes to receive multicast traffic only from source S6 of multicast group address G2. Host 814 sends to router 850 an INCLUDE (G1, {S1}) type membership message having a set of sources S1 indicating that it wishes to receive multicast traffic only from source S1 of multicast group address G1. Host 815 sends to router 840 an EXCLUDE (G2, {S5}) type membership message having a set of sources S5 indicating that it wishes to receive multicast traffic from all sources except source S5 of multicast group address G2. Host 816 sends to router 840 an INCLUDE (G1, {S3}) type membership message having a set of sources S3 indicating that it wishes to receive multicast traffic only from source S3 of multicast group address G1.

As a result of having received the multicast traffic request from hosts 810, 811 and 812, router 840 may create directly from the requests general multicast state records for network interface 842 that include a first record (G1, EXCLUDE{S1}) and a second record (G2, EXCLUDE {S5,S7}). In an alternative implementation router 840 may first create one or more IGMPv3 group records and then create from the one or more group records the general multicast state records.

As a result of having received the multicast traffic request from hosts 815 and 816, router 840 may create directly from the requests general multicast state records for network interface 844 that include a first record (G2, EXCLUDE{S5}) and a second record (G1, INCLUDE {S3}). In an alternative implementation router 840 may first create one or more IGMPv3 group records and then create from the one or more group records the general multicast state records.

As a result of having received the multicast traffic request of hosts 813 and 814, router 850 sends from network interface 852 to the network interface 843 of router 840 a JOIN (S1,G1) message and also a JOIN (S6, G2) message. In return, router 840 creates for network interface 843 a first general multicast state record (G1, INCLUDE {S1}) and a second general multicast state record (G2, INCLUDE {S6}).

Thus, router 840 will have stored six general multicast state records which are used to filter unwanted multicast packets received at network interface 841. The six records being in a form that includes the following information (G1, INCLUDE {S1}); (G1, INCLUDE {S3}); (G1, EXCLUDE {S1}); (G2, INCLUDE {S6}) and (G2, EXCLUDE {S5}), (G2, EXCLUDE{S5, S7}). It is important to note here that the general multicast state records of the present invention are in no way limited to any particular structure. It is only important that the records are capable of being parsed to extract the relevant multicast group address and source address information that enables them to be used to filter multicast packets received in a network interface of a router.

For multicast group address G1 there exist two general multicast state records of the type INCLUDE. As a result, router 840 creates a single INCLUDE type record that includes the union of the set of sources {S1} and {S3} with the following result: (G1, INCLUDE {S1,S3}). Moreover, for multicast group G2 there exist two general multicast state records of the type EXCLUDE. As a result, router 840 creates a single EXCLUDE type record that includes the intersection of the set of sources {S5} and {S5,S7} with the following result: (G2, EXCLUDE {S5}).

Turning now to FIG. 9, and assuming that the network interface 841 is not in promiscuous mode, network interface 841 systematically reads and compares the destination and source address of the IP packets received in the interface with registers/records comprising the information of the four general multicast state records in a manner consistent with the process shown in FIG. 9. It is important to note that the process of FIG. 9 is only one of various methods that may be executed to filter IP packets at interface 841. In any event, in the current example, by virtue of the general multicast state records stored in router 840, network interface 841 will transmit all IP packets through the network interface except those packets having a destination address G2 and a source address S5.

The filtering methods disclosed and contemplated herein also apply to a switch that implements a snooping function to identify the multicast traffic which it has to transmit by each of its ports. Available on the market, there are switches that perform the snooping function for different multicast routing protocols, such as IGMPv2, IGMPv3 and PIM-SM. By means of the snooping process, the switches create multicast status records that determine the multicast traffic that the switch must transmit through each of its ports. In one implementation of the present invention, these multicast status records—used by the switch to determine the multicast traffic to be transmitted by each of its ports—can be used to create the general multicast status records that determine the multicast traffic to be transmitted by the switch via all its ports, in a similar way as that explained above for routers. General multicast status records can be transmitted or stored on the network interface controllers of each of the switch ports, and accordingly the network interface controllers can filter the multicast traffic frames that the switch does not want to receive using the process outlined in FIG. 9.

Embodiments within the scope of the present invention may also include computer-readable media for carrying or having computer-executable instructions or data structures stored thereon. Such computer-readable media can be any available media that can be accessed by a general purpose or special purpose computer, including the functional design of any special purpose processor as discussed above. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, data structures, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention.

TABLE 1
Table 1: Operating example of a prior art IGMPv3 router.

| | STATE 1 | MESSAGE | STATE 2 | ACTIONS |
|---|---|---|---|---|
| 1. | INCLUDE (A) | IS_IN (B) | INCLUDE (A + B) | T (B) = GMI |
| 2. | INCLUDE (A) | IS_EX (B) | EXCLUDE (A * B, B − A) | T (B − A) = 0 |
| | | | | DEL (A − B) |
| | | | | GT = GMI |
| 3. | EXCLUDE (X, Y) | IS_IN (A) | EXCLUDE (X + A, Y − A) | T (A) = GMI |
| 4. | EXCLUDE (X, Y) | IS_EX (A) | EXCLUDE (A − Y, Y * A) | T (A − X − Y) = GMI |
| | | | | DEL (X − A) |
| | | | | DEL (Y − A) |
| | | | | GT = GMI |
| 5. | INCLUDE (A) | ALLOW (B) | INCLUDE (A + B) | T (B) = GMI |
| 6. | INCLUDE (A) | BLOCK (B) | INCLUDE (A) | SEND Q (G, A * B) |
| 7. | INCLUDE (A) | TO_EX (B) | EXCLUDE (A * B, B − A) | T (B − A) = 0 |
| | | | | DEL (A − B) |
| | | | | SEND Q (G, A * B) |
| | | | | GT = GMI |
| 8. | INCLUDE (A) | TO_IN (B) | INCLUDE (A + B) | T (B) = GMI |
| | | | | SEND Q (G, A − B) |
| 9. | EXCLUDE (X, Y) | ALLOW (A) | EXCLUDE (X + A,Y − A) | T (A) = GMI |
| 10. | EXCLUDE (X, Y) | BLOCK (A) | EXCLUDE (X+ (A − Y), Y) | T (A − X − Y) = GT |
| | | | | SEND Q (G,A−Y) |
| 11. | EXCLUDE (X, Y) | TO_EX (A) | EXCLUDE (A − Y, Y * A) | T (A − X − Y) = GT |
| | | | | DEL (X − A) |
| | | | | DEL (Y − A) |
| | | | | SEND Q (G, A − Y) |
| | | | | GT = GMI |
| 12. | EXCLUDE (X, Y) | TO_IN (A) | EXCLUDE (X + A, Y − A) | T (A) = GMI |
| | | | | SEND Q (G, X − A) |
| | | | | SEND Q (G) |

What is claimed is:

1. A method of filtering multicast packets in a third network interface of a router that receives multicast traffic from sources that send multicast packets to at least a first multicast group address, the router having a first and a second network interface, the method comprising:
receiving in the first network interface a first multicast traffic request according to a first multicast routing protocol, the multicast traffic request for the first multicast group address comprising a first set of sources,
receiving in the second network interface a second multicast traffic request according to a second multicast routing protocol, the multicast traffic request for the first multicast group address comprising a second set of sources,
creating from the first and second multicast traffic requests one or more records comprising a set of sources indicative of all of the sources of the first multicast group address requested to be transmitted through the first and second interfaces of the router; and
filtering multicast packets received in the third network interface using the one or more records.

2. A method according to claim 1, wherein the first multicast routing protocol is a host-router multicast routing protocol.

3. A method according to claim 1, wherein the second multicast routing protocol is a router-router multicast routing protocol.

4. A method according to claim 2, wherein the host-router multicast routing protocol is a version of the IGMP or MLD protocol.

5. A method according to claim 3, wherein the router-router multicast routing protocol is a version of the PIM-SM protocol.

6. A method according to claim 1, wherein the first multicast routing protocol is a host-router multicast routing protocol and the second multicast routing protocol is a router-router multicast routing protocol.

7. A method according to claim 6, wherein the host-router multicast routing protocol is a version of the IGMP or MLD protocol and the router-router multicast routing protocol is a version of the PIM-SM protocol.

8. A method according to claim 1, wherein the multicast traffic request according to the second multicast routing protocol is derived from a PIM-SM macro.

9. A method according to claim 1, wherein the first and/or second set of sources is an empty list of sources.

10. A method according to claim 1, wherein the first and second multicast routing protocols are router-to-router multicast routing protocols.

11. A method according to claim 1, wherein the first and second multicast routing protocols are host-to-router multicast routing protocols.

12. A process implemented in a multicast router situated in a data network system between sources that send multicast packets to at least one multicast group address and two or more devices that request data from the at least one multicast group address and one or more of the sources, the multicast router having at least first, second and third network interfaces, the process comprising:
storing for the first network interface and a first multicast group address one or more first multicast routing protocol state records each comprising a set of sources, the one or more first multicast routing protocol state records derived by data requests made by a first one or plurality of devices using a first multicast routing protocol,
storing for the second network interface and the first multicast group address one or more second multicast routing protocol state records each comprising a set of sources, the one or more second multicast routing protocol state records derived by data requests made by a second one or plurality of devices using a second multicast routing protocol,
creating one or more general state records from the one or more first and one or more second multicast routing protocol state records, the one or more general state record each having a set of sources which are indicative of all of the sources of the first multicast group address requested to be transmitted through the first and second interfaces of the router; and
filtering multicast packets received in the third network interface using the one or more general state records.

13. A process according to claim 12, wherein the one or more first multicast routing protocol state records are host-router protocol state records and the one or more second multicast routing protocol state record are router-router protocol state records.

14. A process according to claim 13, wherein the one or more host-router protocol state records are IGMP or MLD protocol type state records.

15. A process according to claim 13, wherein the one or more router-router protocol state records are PIM-SM type state records.

16. A process according to claim 13, wherein the one or more host-router protocol state records are derived from one or more IGMP or MLD protocol type request messages from the first one or plurality of devices and the one or more router-router protocol state records are derived from one or more PIM-SM type request messages from the second one or plurality of devices.

17. A process according to claim 12, wherein the one or more general state records are created at least in part by the union or intersection of the set of sources of the one or more host-router protocol state records and one or more router-router protocol state records.

18. A process according to claim 12, wherein the first one or plurality of devices comprises one or more host and the second one or plurality of devices comprises one or more routers.

19. A process according to claim 12, wherein the first one or plurality of devices comprises one or more proxies and the second one or plurality of devices comprises one or more routers.

20. A process according to claim 16, wherein the one or more general state records comprise a first structure or a second structure, the first structure comprising (multicast-address, filter mode=INCLUDE {source-list}), the second structure comprising (multicast-address, filter mode=EXCLUDE {source-list})

21. A process according to claim 12, wherein the first and second multicast routing protocols are router-to-router multicast routing protocols.

22. A process according to claim 12, wherein the first and second multicast routing protocols are host-to-router multicast routing protocols.

23. A process implemented in a multicast router situated in a data network system between sources that send multicast packets to at least one multicast group address and two or more devices that request data from the at least one multicast group address and one or more of the sources, the multicast router having at least first, second and third network interfaces, the process comprising:
storing for the first network interface and a first multicast group address one or more first multicast routing protocol state records each comprising a set of sources, the one or more first multicast routing protocol state records derived by data requests made by a first one or plurality of devices using a first multicast routing protocol,
storing for the second network interface and the first multicast group address one or more second multicast routing protocol state records each comprising a set of sources, the second multicast routing protocol state records derived by data requests made by a second one or plurality of devices using a second multicast routing protocol,
creating from the one or more second multicast routing protocol state records one or more third state records that are capable of being parsed using the first multicast routing protocol to determine the sources of the first multicast group address requested to be transmitted through the second interface,
creating from the one or more first state records and the one or more third state records one or more fourth state records each comprising a set of sources which are indicative of all of the sources of the first multicast group address requested to be transmitted through the first and second interfaces of the router; and
filtering multicast packets received in the third network interface using the one or more fourth state records.

24. A process according to claim 23, wherein the first multicast routing protocol is a host-router protocol and the second multicast routing protocol is a router-router protocol.

25. A process according to claim 24, wherein the host-router protocol is an IGMP or MLD protocol, or a version thereof.

26. A process according to claim 24, wherein the router-router protocol is the PIM-SM protocol, or a version thereof.

27. A process according to claim 24, wherein the host-router protocol is an IGMP or MLD protocol, or a version thereof, and the router-router protocol is the PIM-SM protocol, or a version thereof.

28. A process according to claim 23, wherein the one or more fourth state records are created at least in part by the union and/or intersection of the set of sources of the one or more first multicast routing protocol state records and the set of sources of the one or more third state records.

29. A process according to claim 23, wherein the first one or plurality of devices comprises one or more host and the second one or plurality of devices comprises one or more routers.

30. A process according to claim 23, wherein the first one or plurality of devices comprises one or more proxies and the second one or plurality of devices comprises one or more routers.

31. A process according to claim 23, wherein the first and second multicast routing protocols are router-to-router multicast routing protocols.

32. A process according to claim 23, wherein the first and second multicast routing protocols are host-to-router multicast routing protocols.

33. A process implemented in a multicast router situated in a data network system between sources that send multicast packets to at least one multicast group address and two or more devices that request data from the at least one multicast group address and one or more of the sources, the multicast router having at least first, second and third network interfaces, the process comprising:
storing for the first network interface and a first multicast group address one or more first multicast routing protocol state records each comprising a set of sources, the one or more first multicast routing protocol state records derived by data requests made by at least a first device using a first multicast routing protocol,
storing for the second network interface and the first multicast group address one or more second multicast routing protocol state records each having a set of sources, the one or more second multicast routing protocol state records derived by data requests made by at least a second device using a second multicast routing protocol,
creating one or more first general state records each having a set of sources and one or more second general state records each having a set of sources from the first and second multicast routing protocol state records, respectively, the first and second general state records storing in a similar or like manner their respective sets of sources,
creating from the first and second general state records one or more third general state records each having a set of sources, the one or more third general state records indicative of all of the sources of the first multicast group address requested to be transmitted through the first and second interfaces of the router; and
filtering multicast packets received in the third network interface using the one or more third general state records.

34. A process according to claim 33, wherein the one or more first multicast routing protocol state records are host-router protocol state records and the one or more second multicast routing protocol state records are router-router protocol state records.

35. A process according to claim 34, wherein the one or more host-router protocol state records are IGMP or MLD protocol type state records.

36. A process according to claim 34, wherein the one or more router-router protocol state records are PIM-SM type state records.

37. A process according to claim 34, wherein the one or more host-router protocol state records are derived from IGMP or MLD protocol type request messages from the first device and the one or more router-router protocol state records are derived from a PIM-SM type request messages from the second device.

38. A process according to claim 33, wherein the one or more third general state records are created at least in part by the union and/or intersection of the set of sources of the one or more first general state records and the one or more second general state records.

39. A process according to claim 33, wherein the first device is host and the second device is a router.

40. A process according to claim 33, wherein the first device is a proxy and the second device is a router.

41. A process according to claim 37, wherein the one or more first, second and third general state records comprise a first structure or a second structure, the first structure comprising (multicast-address, filter mode=INCLUDE {source-list}), the second structure comprising (multicast-address, filter mode=EXCLUDE {source-list})

42. A process according to claim 33, wherein the first and second multicast routing protocols are router-to-router multicast routing protocols.

43. A process according to claim 33, wherein the first and second multicast routing protocols are host-to-router multicast routing protocols.

44. A method of filtering multicast packets in a third network interface of a router that receives multicast traffic from sources that send multicast packets to at least a first multicast group address, the router having a first and a second network interface, the method comprising:
receiving in the first network interface a multicast traffic request according to a first multicast routing protocol, the multicast traffic request for the first multicast address comprising a first set of sources,
receiving in the second network interface a multicast traffic request according to a second multicast routing protocol, the multicast traffic request for the first multicast group address comprising a second set of sources,
creating a first general state record for the first multicast group address comprising a third set of sources based on the first set of sources,
creating a second general state record for the first multicast group address comprising a fourth set of sources based on the second set of sources,
creating from the first and second general state records a third general state record for the first multicast group address that comprises a fifth set of sources that is derived from a union or an intersection of the third and fourth set of sources, the fifth set of sources indicative of all of the sources of the first multicast group address requested to be transmitted through the first and second interfaces of the router; and
filtering multicast packets received in the third network interface using the third general state record.

45. A method according to claim 44, wherein the first multicast routing protocol is a host-router multicast routing protocol.

46. A method according to claim 44, wherein the second multicast routing protocol is a router-router multicast routing protocol.

47. A method according to claim 45, wherein the host-router multicast routing protocol is a version of the IGMP or MLD protocol.

48. A method according to claim 46, wherein the router-router multicast routing protocol is a version of the PIM-SM protocol.

49. A method according to claim 44, wherein the first multicast routing protocol is a host-router multicast routing protocol and the second multicast routing protocol is a router-router multicast routing protocol.

50. A method according to claim 49, wherein the host-router multicast routing protocol is a version of the IGMP or MLD protocol and the router-router multicast routing protocol is a version of the PIM-SM protocol.

51. A method according to claim 50, wherein the first, second and third general state records comprise a first structure or a second structure, the first structure comprising (multicast-address, filter mode=INCLUDE {source-list}), the second structure comprising (multicast-address, filter mode=EXCLUDE {source-list})

52. A method according to claim 48, wherein the multicast traffic request according to the second multicast routing protocol is derived from a PIM-SM macro.

53. A method according to claim 44, wherein the first and second multicast routing protocols are router-to-router multicast routing protocols.

54. A method according to claim 44, wherein the first and second multicast routing protocols are host-to-router multicast routing protocols.

55. A method of filtering multicast packets in a third network interface of a router that receives multicast traffic from sources that send multicast packets to at least a first multicast group address, the router having a first and a second network interface, the method comprising:
receiving in the first network interface a multicast traffic request according to a first multicast routing protocol, the multicast traffic request for the first multicast group address comprising a first set of sources,
receiving in the second network interface a multicast traffic request according to a second multicast routing protocol, the multicast traffic request for the first multicast group address comprising a second set of sources,
creating a general state record for the first multicast group address comprising a third set of sources that is derived from a union or an intersection of the first and second set of sources, the third set of sources indicative of all of the sources of the first multicast group address requested to be transmitted through the first and second interfaces of the router; and
filtering multicast packets received in the third network interface using the general state record.

56. A method according to claim 55, wherein the first multicast routing protocol is a host-router multicast routing protocol.

57. A method according to claim 55, wherein the second multicast routing protocol is a router-router multicast routing protocol.

58. A method according to claim 56, wherein the host-router multicast routing protocol is a version of the IGMP or MLD protocol.

59. A method according to claim 57, wherein the router-router multicast routing protocol is a version of the PIM-SM protocol.

60. A method according to claim 55, wherein the first multicast routing protocol is a host-router multicast routing protocol and the second multicast routing protocol is a router-router multicast routing protocol.

61. A method according to claim 60, wherein the host-router multicast routing protocol is a version of the IGMP or MLD protocol and the router-router multicast routing protocol is a version of the PIM-SM protocol.

62. A method according to claim 60, wherein the general state record comprises a first structure or a second structure, the first structure comprising (multicast-address, filter mode=INCLUDE {source-list}), the second structure comprising (multicast-address, filter mode=EXCLUDE {source-list})

63. A method according to claim 59, wherein the multicast traffic request according to the second multicast routing protocol is derived from a PIM-SM macro.

64. A method according to claim 55, wherein the first and second multicast routing protocols are router-to-router multicast routing protocols.

65. A method according to claim 55, wherein the first and second multicast routing protocols are host-to-router multicast routing protocols.
